(19) United States
(12) Patent Application Publication
(10) Pub. No.: US 2011/0236023 A1
(43) Pub. Date: Sep. 29, 2011

(54) SIGNAL LIGHT PROCESSING APPARATUS, LIGHT TRANSMISSION APPARATUS, WAVELENGTH SELECTION SWITCH, WAVELENGTH DIVISION MULTIPLEXING TRANSMISSION SYSTEM, AND SIGNAL LIGHT PROCESSING METHOD

(75) Inventors: Norifumi Shukunami, Kawasaki (JP); Tatsuya Tsuzuki, Kawasaki (JP); Kentaro Nakamura, Kawasaki (JP)

(73) Assignee: FUJITSU LIMITED, Kawasaki-shi (JP)

(21) Appl. No.: 13/028,619

(22) Filed: Feb. 16, 2011

(30) Foreign Application Priority Data
Mar. 23, 2010 (JP) 2010-066933

(51) Int. Cl. H04J 14/02

(52) U.S. Cl. 398/81

(57) ABSTRACT

A signal light processing apparatus includes a first wavelength selection switch, a dispersion compensator, and a second wavelength selection switch. The first wavelength selection switch divides an input wavelength-multiplexed signal light into signal lights of each wavelength and outputs the signal lights from a first output port or a second output port in accordance with wavelengths of the divided signal lights. The dispersion compensator compensates dispersion compensation on the signal light output from the first output port by the first wavelength selection switch. The second wavelength selection switch combines the signal light on which dispersion compensation is compensated by the dispersion compensator and the signal light output from the second output port by the first wavelength selection switch.

### CROSS-REFERENCE TO RELATED APPLICATION

This application is based upon and claims the benefit of priority of the prior Japanese Patent Application No. 2010-066933, filed on Mar. 23, 2010, the entire contents of which are incorporated herein by reference.

### FIELD

The embodiments discussed herein are directed to a signal light processing apparatus, a light transmission apparatus, a wavelength selection switch, and a signal light processing method.

### BACKGROUND

Currently, in a Wavelength Division Multiplexing (WDM) transmission system, for example, a direct detection method is employed as a receiving method for transmitting data at a speed of “10 Gbit/s” or “40 Gbit/s”. The direct detection method is a method for performing receiving processing by directly converting a change in intensity of signal light to a change in electrical signal by a light receiving element.

When the direct detection method is employed, in a wavelength-multiplexed signal light transmitted from a transmitter, a waveform distortion occurs in a transmission path such as an optical fiber. Therefore, in an optical transmission system in which the direct detection method is employed, a Dispersion Compensation Module (DCM) is disposed in a repeater or a light receiver provided in a transmission path, and dispersion compensation of a wavelength is compensated by the DCM.

By the way, in recent years, for a large-capacity optical transmission system, it is desired that the transmission speed is improved to 100 Gbit/s, and a digital coherent receiving method is being developed as a receiving method for 100 Gbit/s transmission. The digital coherent receiving method is a method in which a light receiver compensates dispersion compensation on a signal phase-modulated by a light transmitter by high-speed digital signal processing. If such a digital coherent receiving method is realized, it is not necessary to provide a DCM and an optical amplifier that compensates a loss in the DCM in the repeater and the light receiver.

Patent Document 1: Japanese Laid-open Patent Publication No. 2008-167297

However, in the above-described conventional technique, there is a problem that, when the digital coherent receiving method is introduced, a repeater for the direct detection method and a repeater for the digital coherent receiving method are designed and manufactured.

Specifically, in the future, when the digital coherent receiving method is introduced, either a signal received by the digital coherent receiving method (hereinafter referred to as “digital coherent signal”) or a signal received by the direct detection method (hereinafter referred to as “direct detection signal”) is used for a receiver. In this case, a conventional repeater that relays a direct detection signal also compensates the dispersion compensation on a digital coherent signal. This causes a problem that the Signal Noise Ratio (SN ratio) of the digital coherent signal deteriorates, and as a result, the transmission distance of the digital coherent signal decreases.

Therefore, in order to relay a digital coherent signal without deteriorating the SN ratio, it is necessary to design and manufacture a repeater that does not include a DCM and an optical amplifier. Even when the digital coherent receiving method is introduced, the direct detection signal is also transmitted, and thus a repeater that includes a DCM and an optical amplifier is also designed and manufactured. As a result, a repeater for the direct detection method and a repeater for the digital coherent receiving method need to be designed and manufactured, so that it takes time and cost.

### SUMMARY

According to an aspect of an embodiment of the invention, a signal light processing apparatus includes: a first wavelength selection switch that divides an input wavelength-multiplexed signal light into signal lights of each wavelength and outputs the signal lights from a first output port or a second output port in accordance with wavelengths of the divided signal lights; a dispersion compensator that compensates dispersion compensation on the signal light output from the first output port by the first wavelength selection switch; and a second wavelength selection switch that combines the signal light on which dispersion compensation is compensated by the dispersion compensator and the signal light output from the second output port by the first wavelength selection switch.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram illustrating a configuration example of a signal light processing apparatus according to a first embodiment;

FIG. 2 is a block diagram illustrating a configuration example of a WDM system including a repeater according to a second embodiment;

FIG. 3 is a block diagram illustrating a configuration example of the repeater according to the second embodiment;

FIG. 4 is a diagram illustrating a configuration example of a branch unit illustrated in FIG. 3;

FIG. 5 is a schematic diagram of the branch unit illustrated in FIG. 4;

FIG. 6 is a schematic diagram of the branch unit illustrated in FIG. 4;

FIG. 7 is a block diagram illustrating a configuration example of a repeater according to a third embodiment;

FIG. 8 is a schematic diagram of a WSS 921 in which one port is added to a WSS illustrated in FIG. 5;

FIG. 9 is a schematic diagram of the WSS 921 in which one port is added to the WSS illustrated in FIG. 5;

FIG. 10 is a schematic diagram of a WSS illustrated in FIG. 7;

FIG. 11 is a schematic diagram of the WSS illustrated in FIG. 7;

FIG. 12 is a schematic diagram of a WSS according to a fourth embodiment;

FIG. 13 is a schematic diagram of the WSS according to the fourth embodiment;

FIG. 14 is a schematic diagram of the WSS according to the fourth embodiment;

FIG. 15 is a block diagram illustrating a configuration example of a repeater according to a fifth embodiment;

FIG. 16 is a diagram illustrating a configuration example of a WDM system according to a sixth embodiment;

FIG. 17 is a diagram illustrating a configuration example of a WDM system according to a seventh embodiment; and

FIG. 18 is a schematic diagram of a WSS illustrated in FIG. 17.

### DESCRIPTION OF EMBODIMENTS

Preferred embodiments will be explained with reference to accompanying drawings.

These embodiments do not limit the signal light processing apparatus, the light transmission apparatus, the wavelength selection switch, and the signal light processing method disclosed in this application.

### [a] First Embodiment

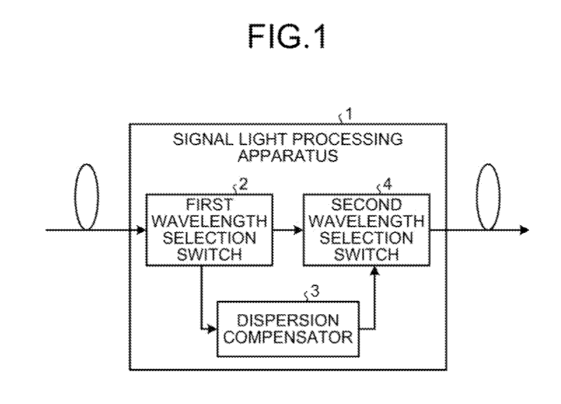

First, the signal light processing apparatus according to a first embodiment will be described with reference to FIG. 1. FIG. 1 is a block diagram illustrating a configuration example of the signal light processing apparatus according to the first embodiment. As illustrated in FIG. 1, a signal light processing apparatus 1 according to the first embodiment includes a first wavelength selection switch 2, a dispersion compensator 3, and a second wavelength selection switch 4.

The first wavelength selection switch 2 divides an input wavelength-multiplexed signal light into signal lights of each wavelength. Then, the first wavelength selection switch 2 outputs the divided signal lights from a first output port or a second output port in accordance with the wavelength of the signal lights.

Specifically, the first wavelength selection switch 2 divides the wavelength-multiplexed signal light into signal lights of each wavelength, and then, outputs a signal light which is a target of dispersion compensation from the first output port and outputs a signal light which is not the target of dispersion compensation from the second output port. Here, the first output port is connected to the dispersion compensator 3, and the second output port is connected to the second wavelength selection switch 4.

The dispersion compensator 3 compensates dispersion compensation on the signal light output from the first output port by the first wavelength selection switch 2. The second wavelength selection switch 4 combines the signal light on which the dispersion compensation is compensated by the dispersion compensator 3 and the signal light output from the second output port by the first wavelength selection switch 2.

In this way, the signal light processing apparatus 1 according to the first embodiment divides the input wavelength-multiplexed signal light into the signal light which is the target of dispersion compensation and the signal light which is not the target of dispersion compensation. Then, the signal light processing apparatus 1 outputs the signal light which is the target of dispersion compensation to the dispersion compensator 3, and outputs the signal light which is not the target of dispersion compensation to the second wavelength selection switch 4. Then, the signal light processing apparatus 1 combines the signal light on which the dispersion compensation has been compensated and the signal light which is not the target of dispersion compensation. Based on this, even when a wavelength-multiplexed signal light which includes the signal light which is the target of dispersion compensation and the signal light which is not the target of dispersion compensation is input into the signal light processing apparatus 1 according to the first embodiment, the signal light processing apparatus 1 can transmit the wavelength-multiplexed signal light without degrading the wavelength-multiplexed signal light.

For example, the signal light processing apparatus 1 divides the input wavelength-multiplexed signal light into a signal light corresponding to the wavelength of the digital coherent signal and a signal light corresponding to the wavelength of the direct detection signal. The signal light processing apparatus 1 does not compensate the dispersion compensation on the digital coherent signal, and compensates the dispersion compensation on the direct detection signal. Then, the signal light processing apparatus 1 combines the digital coherent signal and the direct detection signal on which the dispersion compensation has been compensated, and then outputs the combined signal. Based on this, even when a wavelength-multiplexed signal light in which the direct detection signal and the digital coherent signal are wavelength-multiplexed is input into the signal light processing apparatus 1, the signal light processing apparatus 1 can compensate the waveform distortion of the direct detection signal generated in a transmission path because the signal light processing apparatus 1 compensates the dispersion compensation on the direct detection signal. The signal light processing apparatus 1 does not compensate the dispersion compensation on the digital coherent signal, and thus it is possible to prevent the SN ratio of the digital coherent signal from being degraded. As described above, the signal light processing apparatus 1 can compensate signal light processing suitable for the types of the signal lights included in the wavelength-multiplexed signal light. As a result, according to the first embodiment, it is not necessary to design and manufacture signal light processing apparatuses for each type of the signal lights, so that the time and cost required for the design and manufacturing can be saved.

### [b] Second Embodiment

Next, in a second embodiment, an example will be described in which the signal light processing apparatus 1 described in the above first embodiment is applied to a repeater. In the second embodiment, first, a WDM system including a repeater according to the second embodiment will be described, and then, the repeater according to the second embodiment will be described.

Configuration of WDM system including a repeater according to the second embodiment

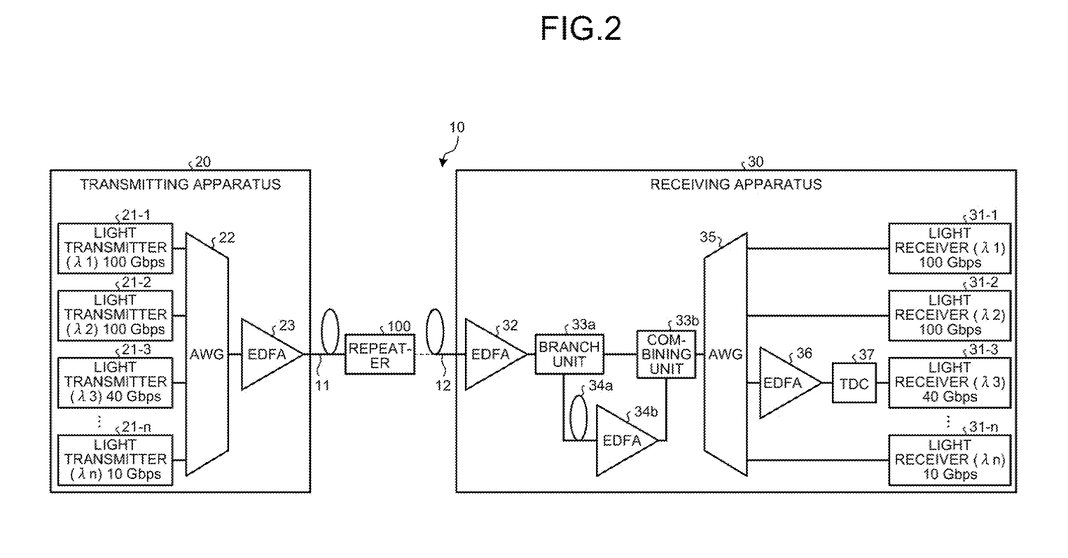

First, the WDM system including a repeater according to the second embodiment will be described with reference to FIG. 2. FIG. 2 is a block diagram illustrating a configuration example of the WDM system including a repeater according to the second embodiment. As illustrated in FIG. 2, a WDM system 10 in the second embodiment includes a transmitting apparatus 20, a receiving apparatus 30, and a repeater 100.

In an example illustrated in FIG. 2, the transmitting apparatus 20 and the repeater 100 are connected by a transmission path 11, and the receiving apparatus 30 and the repeater 100 are connected by a transmission path 12. The transmission path 11 and the transmission path 12 are, for example, an optical fiber. Although, in FIG. 2, an example is illustrated in which one repeater 100 is disposed between the transmitting apparatus 20 and the receiving apparatus 30, two or more repeaters may be disposed between the transmitting apparatus 20 and the receiving apparatus 30.

As illustrated in FIG. 2, the transmitting apparatus 20 includes light transmitters 21-1 to 21-n, an Arrayed Waveguide Grating (AWG) 22, and an Erbium Doped Fiber Amplifiers (EDFA) 23.

The light transmitters 21-1 to 21-n generate a signal light and output the generated signal light to the AWG 22. For example, external apparatuses such as a router and a switch (not illustrated) are connected to the light transmitters 21-1 to 21-n, and the light transmitters 21-1 to 21-n convert signals input from the external apparatuses into signal lights having a predetermined wavelength, and output the converted signal lights to the AWG 22.

In the example illustrated in FIG. 2, the light transmitters 21-1 and 21-2 correspond to a transmission speed of 100 Gbit/s, the light transmitter 21-3 corresponds to a transmission speed of 40 Gbit/s, and the light transmitter 21-n corresponds to a transmission speed of 10 Gbit/s. In the example illustrated in FIG. 2, the light transmitter 21-1 transmits a signal light having a wavelength of λ1, the light transmitter 21-2 transmits a signal light having a wavelength of λ2, and the light transmitter 21-n transmits a signal light having a wavelength of λn. Specifically, the light transmitter 21-1 transmits a digital coherent signal having a wavelength of λ1 and the light transmitter 21-2 transmits a digital coherent signal having a wavelength of λ2. The light transmitter 21-3 transmits a direct detection signal having a wavelength of λ3 and the light transmitter 21-n transmits a direct detection signal having a wavelength of λn.

The AWG 22 wavelength-multiplexes a plurality of signal lights having different wavelengths and outputs a wavelength-multiplexed signal light that has been wavelength-multiplexed to the EDFA 23. Specifically, the AWG 22 wavelength-multiplexes the signal lights input from the light transmitters 21-1 to 21-n, and outputs a wavelength-multiplexed signal light that has been wavelength-multiplexed to the EDFA 23.

The EDFA 23 optically amplifies an input signal light. Specifically, the EDFA 23 optically amplifies the wavelength-multiplexed signal light input from the AWG 22, and transmits the wavelength-multiplexed signal light that has been optically amplified to the transmission path 11.

The wavelength-multiplexed signal light transmitted to the transmission path 11 by the transmitting apparatus 20 as described above is transmitted to the receiving apparatus 30 via the repeater 100 and the transmission path 12. Here, the repeater 100 according to the second embodiment does not compensate the dispersion compensation on the digital coherent signal in the wavelength-multiplexed signal light transmitted from the transmitting apparatus 20, and compensates the dispersion compensation on the direct detection signal in the wavelength-multiplexed signal light. Then, the repeater 100 combines the digital coherent signal and the direct detection signal on which the dispersion compensation has been compensated, and then transmits the combined wavelength-multiplexed signal light to the receiving apparatus 30.

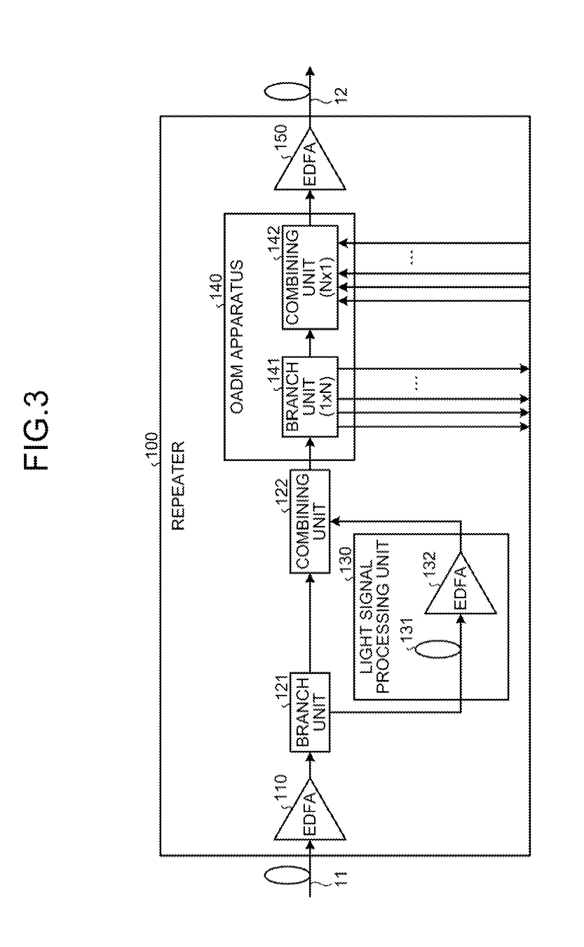

Here, a configuration of the repeater 100 according to the second embodiment will be described with reference to FIG. 3. FIG. 3 is a block diagram illustrating a configuration example of the repeater 100 according to the second embodiment. As illustrated in FIG. 3, the repeater 100 according to the second embodiment is, for example, a light transmission apparatus, and includes an EDFA 110, a branch unit 121, a combining unit 122, a light signal processing unit 130, an Optical Add Drop Multiplexing (OADM) apparatus 140, and an EDFA 150.

The EDFA 110 optically amplifies a wavelength-multiplexed signal light input from outside. In an example illustrated in FIG. 3, a wavelength-multiplexed signal light is input into the EDFA 110 from the transmission path 11, and the EDFA 110 optically amplifies the wavelength-multiplexed signal light.

The branch unit 121 is, for example, a wavelength selection switch such as a Wavelength Selectable Switch (WSS), and includes one input port and two output ports. In the example illustrated in FIG. 3, the input port of the branch unit 121 is connected to the EDFA 110. A first output port of the branch unit 121 is connected to the light signal processing unit 130, and a second output port is connected to the combining unit 122.

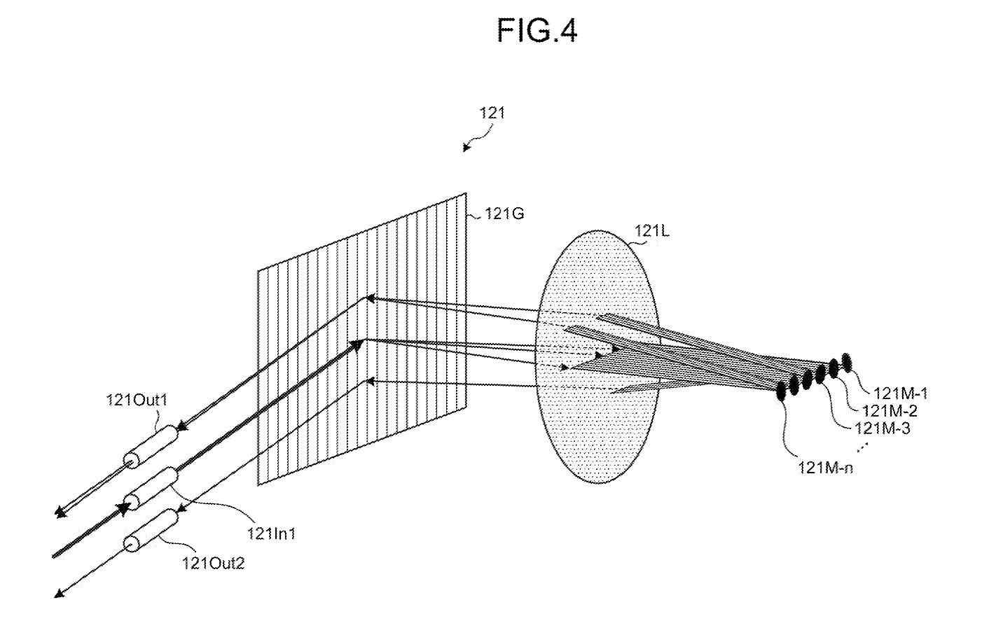

The branch unit 121 divides the wavelength-multiplexed signal light input from the EDFA 110 into signal lights of each wavelength. Then, the branch unit 121 outputs the digital coherent signal among the divided signal lights to the combining unit 122 and outputs the direct detection signal to the light signal processing unit 130. The branch unit 121 corresponds to the first wavelength selection switch 2 illustrated in FIG. 1. A configuration of the branch unit 121 will be described below with reference to FIG. 4.

The light signal processing unit 130 compensates light signal processing on an input signal light. In the example illustrated in FIG. 3, the light signal processing unit 130 includes a DCM 131 and an EDFA 132. The DCM 131 compensates the dispersion compensation on the direct detection signal input from the branch unit 121. The EDFA 132 optically amplifies the dispersion-compensated direct detection signal input from the DCM 131, and outputs the optically amplified direct detection signal to the combining unit 122. The DCM 131 corresponds to the dispersion compensator 3 illustrated in FIG. 1.

The combining unit 122 is, for example, a wavelength selection switch such as a WSS, and includes two input ports and one output port. In the example illustrated in FIG. 3, a first input port of the combining unit 122 is connected to the light signal processing unit 130, and a second input port is connected to the branch unit 121. The output port of the combining unit 122 is connected to the OADM apparatus 140.

The combining unit 122 combines the digital coherent signal input from the branch unit 121 and the direct detection signal input from the EDFA 132, and outputs the combined wavelength-multiplexed signal light to the OADM apparatus 140. The combining unit 122 corresponds to the second wavelength selection switch 4 illustrated in FIG. 1.

In this way, the branch unit 121 outputs the digital coherent signal included in the wavelength-multiplexed signal light to the combining unit 122 and outputs the direct detection signal to the light signal processing unit 130. Then, the combining unit 122 combines the digital coherent signal and the direct detection signal on which the dispersion compensation has been compensated by the light signal processing unit 130. Based on this, even when the repeater 100 relays a wavelength-multiplexed signal light in which the digital coherent signal and the direct detection signal are wavelength-multiplexed, it is possible for the repeater 100 not to compensate the dispersion compensation on the digital coherent signal, but to compensate the dispersion compensation on the direct detection signal.

The OADM apparatus 140 branches (drops) a part of signal light included in the wavelength-multiplexed signal light to another network or another receiver and inserts (adds) a signal light transmitted from another network or another transmitter. In the example illustrated in FIG. 3, the OADM apparatus 140 includes a branch unit 141 and a combining unit 142.

The branch unit 141 is, for example, a wavelength selection switch such as an optical coupler or a WSS, and includes one input port and N output ports. The branch unit 141 divides the wavelength-multiplexed signal light input from the combining unit 122 into signal lights of each wavelength. Then, the branch unit 141 drops a part of the divided signal lights on another network or another receiver not illustrated in FIG. 3. Also, the branch unit 141 outputs a part of the divided signal lights to the combining unit 142.

The combining unit 142 is, for example, a wavelength selection switch such as an optical coupler or a WSS, and includes N input ports and one output port. The combining unit 142 combines the signal light input from the branch unit 141 and signal lights input from other transmitters not illustrated in FIG. 3, and outputs the combined wavelength-multiplexed signal light to the EDFA 150.

The EDFA 150 optically amplifies the wavelength-multiplexed signal light input from the combining unit 142. Then, the EDFA 150 transmits the optically amplified wavelength-multiplexed signal light to outside. In the example illustrated in FIG. 3, the EDFA 150 transmits the wavelength-multiplexed signal light to the transmission path 12.

Return to the description of FIG. 2. A configuration of the receiving apparatus 30 will be described. The receiving apparatus 30 includes light receivers 31-1 to 31-n, an EDFA 32, a branch unit 33a, a combining unit 33b, a DCM 34a, an EDFA 34b, an AWG 35, an EDFA36, and a Tunable Dispersion Compensator (TDC) 37.

The light receivers 31-1 to 31-n compensates reception processing such as demodulation processing on an input signal light. In the example illustrated in FIG. 2, the light receivers 31-1 and 31-2 correspond to a transmission speed of 100 Gbit/s, the light receiver 31-3 corresponds to a transmission speed of 40 Gbit/s, and the light receiver 31-n corresponds to a transmission speed of 10 Gbit/s. In the example illustrated in FIG. 2, the light receiver 31-1 compensates reception processing on a signal light having a wavelength of λ1, the light receiver 31-2 compensates reception processing on a signal light having a wavelength of λ2, and the light receiver 21-n compensates reception processing on a signal light having a wavelength of λn.

The EDFA 32 optically amplifies all the wavelengths of the wavelength-multiplexed signal light received from the repeater 100 via the transmission path 12 at the same time. In the same manner as the branch unit 121 illustrated in FIG. 2, the branch unit 33a is, for example, a wavelength selection switch such as a WSS, and includes one input port and two output ports. The branch unit 33a divides the wavelength-multiplexed signal light input from the EDFA 32 into signal lights of each wavelength. Then, the branch unit 33a outputs the digital coherent signal among the divided signal lights to the combining unit 33b and outputs the direct detection signal to the DCM 34a.

The DCM 34a compensates the dispersion compensation on the direct detection signal input from the branch unit 33a. The EDFA 34b optically amplifies the dispersion-compensated direct detection signal input from the DCM 34a, and outputs the optically amplified direct detection signal to the combining unit 33b.

The combining unit 33b is, for example, a wavelength selection switch such as a WSS, and includes two input ports and one output port. The combining unit 33b combines the digital coherent signal input from the branch unit 33a and the direct detection signal input from the EDFA 34b, and outputs the combined wavelength-multiplexed signal light to the AWG 35.

The AWG 35 divides the wavelength-multiplexed signal light input from the combining unit 33b into signal lights of each wavelength. Then, the AWG 35 outputs the divided signal lights to any one of the light receivers 31-1 to 31-n respectively in accordance with the wavelength of the divided signal lights. In the example illustrated in FIG. 2, the AWG 35 outputs a signal light having a wavelength of λ1 among the divided signal lights to the light receiver 31-1, outputs a signal light having a wavelength of λ2 to the light receiver 31-2, outputs a signal light having a wavelength of λ3 to an EDFA 36, and outputs a signal light having a wavelength of λn to the light receiver 31-n.

The EDFA 36 optically amplifies the signal light output from the AWG 35. The TDC 37 compensates the dispersion compensation on the optically amplified signal light output from the EDFA 36. The reason why the TDC 37 compensates the dispersion compensation is because the wavelength dispersion tolerance of a signal light transmitted at a transmission speed of 40 Gbit/s is smaller than that of a signal light transmitted at a transmission speed of 10 Gbit/s. In other words, the TDC 37 compensates the dispersion compensation to compensate for insufficiency of the dispersion compensation compensated by the repeater 100.

In this way, in the WDM system 10 according to the second embodiment, it is possible to relay the wavelength-multiplexed signal light, in which the digital coherent signal and the direct detection signal are wavelength-multiplexed, by the repeater 100.

Configuration of the branch unit in the second embodiment

Next, a configuration of the branch unit 121 illustrated in FIG. 3 will be described with reference to FIG. 4. FIG. 4 is a diagram illustrating a configuration example of the branch unit 121 illustrated in FIG. 3. FIG. 4 illustrates a configuration example of a WSS including one input port and two output ports.

As illustrated in FIG. 4, the WSS which realizes the branch unit 121 includes an input port 121In1, a first output port 121Out1, and a second output port 121Out2. The input port 121In1, the first output port 121Out1, and the second output port 121Out2 are, for example, an optical fiber array.

The input port 121In1 is a port into which a signal light is input, and connected to an EDFA 110 illustrated in FIG. 3. The first output port 121Out1 and the second output port 121Out2 are ports from which a signal light is output, and connected to the combining unit 122 or the light signal processing unit 130. In an example illustrated in FIG. 4, the first output port 121Out1 is connected to the light signal processing unit 130, and the second output port 121Out2 is connected to the combining unit 122.

The branch unit 121 includes a diffraction grating 121G, a lens 121L, and mirrors 121M-1 to 121M-n. The diffraction grating 121G is a divider/combiner which divides a signal light into signal lights of each wavelength and combines a plurality of signal lights. For example, the diffraction grating 121G divides a signal light incoming from the input port 121In1 into signal lights of each wavelength. For example, the diffraction grating 121G combines signal lights incoming from the lens 121L. The lens 121L focuses a plurality of signal lights. For example, the lens 121L focuses signal lights incoming from the mirrors 121M-1 to 121M-n onto the diffraction grating 121G.

The mirrors 121M-1 to 121M-n reflect signal lights divided by the diffraction grating 121G. The mirrors 121M-1 to 121M-n are, for example, Micro Electro Mechanical Systems (MEMS), Liquid Crystal On Silicon (LCOS), or the like, and can change reflection angles.

The number (n) of the mirrors 121M-1 to 121M-n corresponds to, for example, the number of wavelengths of the signal lights divided by the diffraction grating 121G. Each of the mirrors 121M-1 to 121M-n is disposed in a position which a signal light having a predetermined wavelength enters. For example, the mirror 121M-1 is disposed in a position which a signal light having a wavelength of λ1 enters, the mirror 121M-2 is disposed in a position which a signal light having a wavelength of λ2 enters, and the mirror 121M-n is disposed in a position which a signal light having a wavelength of λn enters. As a result, in this example, the mirror 121M-1 reflects a signal light having a wavelength of λ1, the mirror 121M-2 reflects a signal light having a wavelength of λ2, and the mirror 121M-n reflects a signal light having a wavelength of λn.

The reflection angles of the mirrors 121M-1 to 121M-n are respectively adjusted in accordance with destinations of the signal lights reflected by the mirrors 121M-1 to 121M-n. For example, the mirror 121M-1 is disposed in a position which reflects a signal light having a wavelength of λ1, and the second output port 121Out2 outputs a signal light having a wavelength of λ1. In this case, the reflection angle of the mirror 121M-1 is adjusted so that a signal light having a wavelength of λ1 enters the second output port 121Out2.

In the example illustrated in FIG. 4, the mirror 121M-1 and the mirror 121M-2 reflect incident signal lights to a lower part of the lens 121L. Based on this, the signal lights reflected by the mirror 121M-1 and the mirror 121M-2 enter the second output port 121Out2 via the diffraction grating 121G. Also, for example, the mirror 121M-3 and the mirror 121M-n reflect incident signal lights to an upper part of the lens 121L. Based on this, the signal lights reflected by the mirror 121M-3 and the mirror 121M-n enter the first output port 121Out1 via the diffraction grating 121G.

Here, as described above, the first output port 121Out1 is connected to the light signal processing unit 130, and the second output port 121Out2 is connected to the combining unit 122. Therefore, the reflection angle of a mirror which reflects a signal light having a wavelength corresponding to the direct detection signal is adjusted so that the reflected light enters the first output port 121Out1 in the manner of the mirror 121M-3 illustrated in FIG. 4. On the other hand, the reflection angle of a mirror which reflects a signal light having a wavelength corresponding to the digital coherent signal is adjusted so that the reflected light enters the second output port 121Out2 in the manner of the mirror 121M-1 illustrated in FIG. 4. In this way, the branch unit 121 can output the digital coherent signal to the combining unit 122 and output the direct detection signal to the light signal processing unit 130.

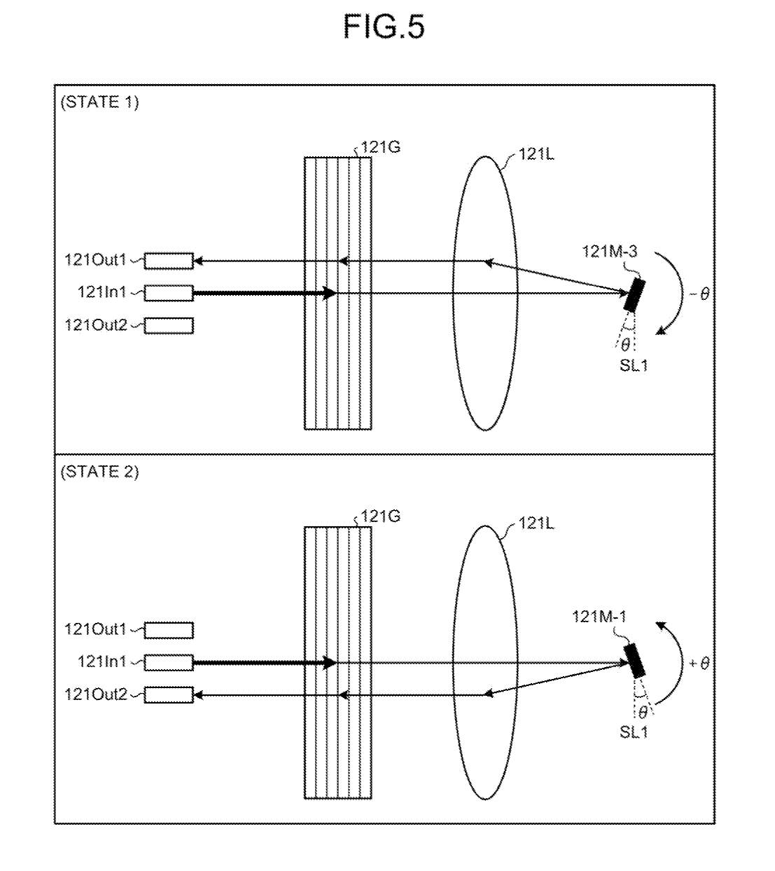

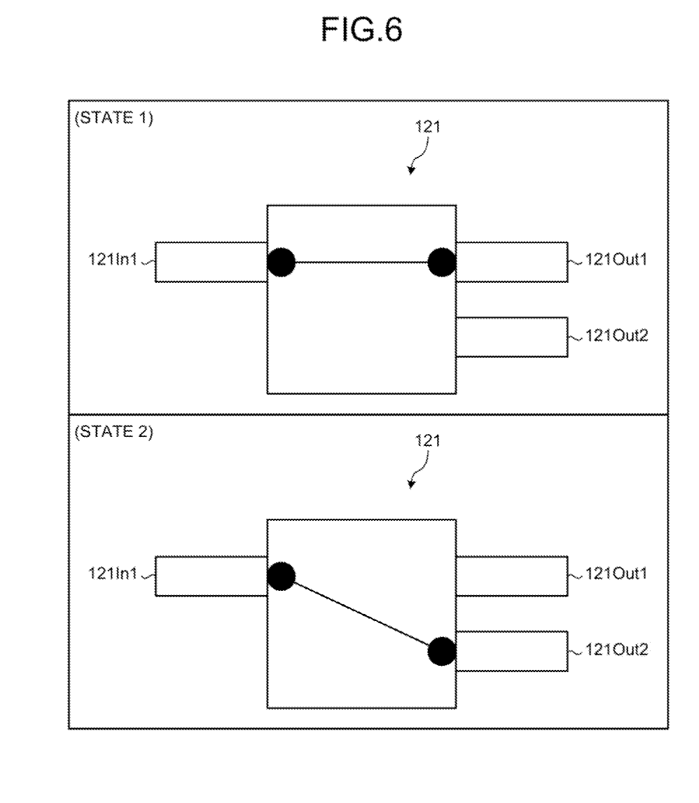

Here, FIGS. 5 and 6 illustrate schematic diagrams of the branch unit 121 illustrated in FIG. 4. In FIGS. 5 and 6, the mirror 121M-1 and the mirror 121M-3 illustrated in FIG. 4 will be described as an example. In examples illustrated in FIGS. 5 and 6, the mirror 121M-3 is disposed in a position which reflects a signal light having a wavelength of λ3. The mirror 121M-3 is disposed so that an angle between the mirror 121M-3 and a predetermined reference line SL1 is “−θ” in order that the reflected light enters the first output port 121Out1. The mirror 121M-1 is disposed in a position which reflects a signal light having a wavelength of λ1. The mirror 121M-1 is disposed so that an angle between the mirror 121M-1 and the predetermined reference line SL1 is “+θ” in order that the reflected light enters the second output port 121Out2.

In an example illustrated in FIG. 5 (state 1), a signal light having a wavelength of λ3 among the signal lights divided by the diffraction grating 121G enters the mirror 121M-3. The mirror 121M-3 reflects the incoming signal light having the wavelength of λ3. Here, the reflection angle of the mirror 121M-3 is adjusted so that the light reflected by the mirror 121M-3 enters the first output port 121Out1. Therefore, the signal light having the wavelength of λ3 reflected by the mirror 121M-3 enters the first output port 121Out1. In this way, the signal light having the wavelength of λ3 among the signal lights entering the input port 121In1 is output to the first output port 121Out1. As a result, in the example illustrated in FIG. 5 (state 1), a signal light is transmitted and received between the input port 121In1 and the first output port 121Out1 as illustrated in FIG. 6 (state 1).

In an example illustrated in FIG. 5 (state 2), a signal light having a wavelength of λ1 among the signal lights divided by the diffraction grating 121G enters the mirror 121M-1. The mirror 121M-1 reflects the signal light having the wavelength of λ1 so that the reflected light enters the second output port 121Out2. In this way, the signal light having the wavelength of λ1 among the signal lights entering the input port 121In1 is output to the second output port 121Out2. As a result, the input port 121In1 and the second output port 121Out2 are connected to each other as illustrated in FIG. 6 (state 2).

The configuration of the combining unit 122 illustrated in FIG. 3 is the same as the configuration of the WSS illustrated in FIG. 4. However, in the combining unit 122, the input port 121In1 illustrated in FIG. 4 is the output port, and the first output port 121Out1 and the second output port 121Out2 illustrated in FIG. 4 are the input ports.

### Effect of the Second Embodiment

As described above, the repeater 100 according to the second embodiment does not compensate the dispersion compensation on the digital coherent signal included in the received wavelength-multiplexed signal light, and compensates the dispersion compensation on the direct detection signal included in the wavelength-multiplexed signal light. Then, the repeater 100 combines the digital coherent signal and the dispersion-compensated direct detection signal, and then transmits the combined signal. Based on this, even when the repeater 100 receives a wavelength-multiplexed signal light in which the digital coherent signal and the direct detection signal are wavelength-multiplexed, the repeater 100 can compensate the waveform distortion of the direct detection signal and prevent the SN ratio of the digital coherent signal from being degraded. As a result, according to the second embodiment, it is not necessary to design and manufacture repeaters for each type of the signal lights, so that the time and cost required for the design and manufacturing can be saved.

In the above-described second embodiment, as illustrated by the example in FIG. 2, the configuration of the WDM system in which the repeater 100 is disposed between the transmitting apparatus 20 and the receiving apparatus 30 is described as an example. However, the repeater 100 according to the second embodiment can be applied to a WDM system having a configuration other than the configuration illustrated in FIG. 2. For example, the repeater 100 according to the second embodiment can be applied to a WDM system of a ring-shaped network in which a plurality of repeaters 100 are connected to each other in a ring shape.

### [c] Third Embodiment

In the above-described second embodiment, an example is illustrated which uses the branch unit 121 which is a WSS including one input port and two output ports and the combining unit 122 which is a WSS including two input ports and one output port. However, the repeater may divide and combine signal lights by using one WSS. In a third embodiment, an example of a repeater which divides and combines signal lights by using one WSS will be described.

### Configuration of the Repeater According to the Third Embodiment

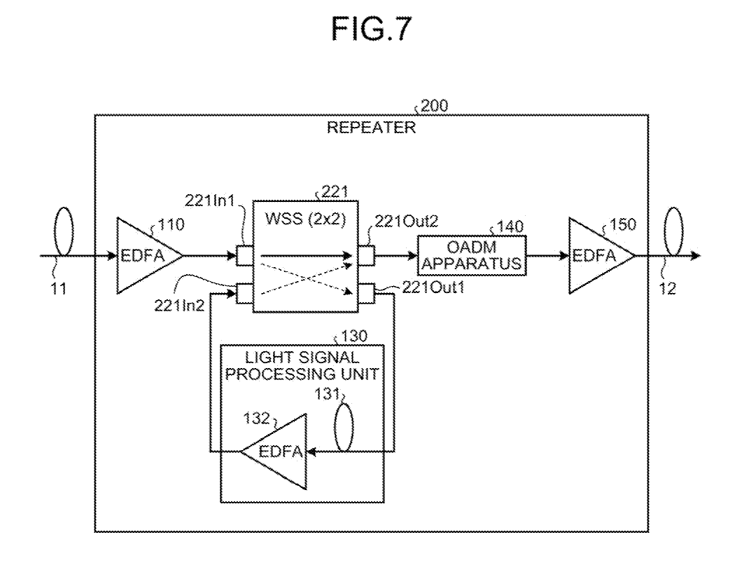

First, a configuration of the repeater according to the third embodiment will be described with reference to FIG. 7. FIG. 7 is a block diagram illustrating a configuration example of the repeater according to the third embodiment. As illustrated in FIG. 7, a repeater 200 according to the third embodiment includes the EDFA 110, the light signal processing unit 130, the OADM apparatus 140, the EDFA 150, and a WSS 221. Hereinafter, the same reference numerals are given to constituent elements that have the same functions as those of the constituent elements that have already been described, and the description thereof will not be repeated here.

The WSS 221 includes a first input port 221In1, a second input port 221In2, a first output port 221Out1, and a second output port 221Out2. In an example illustrated in FIG. 7, the first input port 221In1 is connected to the EDFA 110, and the second input port 221In2 is connected to the EDFA 132 of the light signal processing unit 130. The first output port 221Out1 is connected to DCM 131 of the light signal processing unit 130, and the second output port 221Out2 is connected to the OADM apparatus 140.

When a wavelength-multiplexed signal light is input into the first input port 221In1 from the EDFA 110, the WSS 221 divides the wavelength-multiplexed signal light. Then, the WSS 221 outputs the digital coherent signal after the division to the OADM apparatus 140 via the second output port 221Out2, and outputs the direct detection signal to the light signal processing unit 130 via the first output port 221Out1. Here, the direct detection signal output to the light signal processing unit 130 is dispersion-compensated by the light signal processing unit 130, and input into the second input port 221In2 of the WSS 221. At this time, the WSS 221 combines the digital coherent signal included in the wavelength-multiplexed signal light input from the EDFA 110 and the dispersion-compensated direct detection signal input from the light signal processing unit 130, and outputs the combined wavelength-multiplexed signal light to the OADM apparatus 140.

In this way, the repeater 200 according to the third embodiment can divide the wavelength-multiplexed signal light by using one WSS 221, and combine the digital coherent signal and the dispersion-compensated direct detection signal.

### Configuration of the WSS in the Third Embodiment

Next, a configuration of the WSS 221 illustrated in FIG. 7 will be described. The WSS 221 is required to perform at least switching operations described in (1) and (2) below.
(1) An operation to switch a signal light having a predetermined first wavelength from the first input port 221In1 to the first output port 221Out1 and switch a signal light having the same wavelength as the first wavelength from the second input port 221In2 to the second output port 221Out2.
(2) An operation to switch a signal light having a predetermined second wavelength from the first input port 221In1 to the second output port 221Out2.

The first wavelength illustrated in the above (1) corresponds, for example, to the wavelength of the direct detection signal. The second wavelength illustrated in the above (2) corresponds, for example, to the wavelength of the digital coherent signal.

The reason why the WSS 221 is required to perform the switching operations described in the above (1) and (2) will be described. By performing the switching operation of the above (1), the WSS 221 can output the direct detection signal to the light signal processing unit 130 and combine the digital coherent signal and the dispersion-compensated direct detection signal. In addition, by performing the switching operation of the above (2), the WSS 221 can output the digital coherent signal to the OADM apparatus 140 without passing through the light signal processing unit 130. As a result, the WSS 221 can combine the digital coherent signal and the dispersion-compensated direct detection signal by performing the switching operations described in the above (1) and (2).

It is considered that such a WSS 221 can be realized by adding one port to the WSS illustrated in FIG. 5. For example, it is also considered that the WSS 221 can be realized by adding one output port to a WSS which includes two input ports and one output port. However, by only adding one port to the WSS illustrated in FIG. 5, it is not necessarily able to realize a WSS that can perform the switching operations described in the above (1) and (2). Hereinafter, an example of the WSS in which one port is added to the WSS illustrated in FIG. 5 will be described, and following that, the configuration of the WSS 221 illustrated in FIG. 7 will be described.

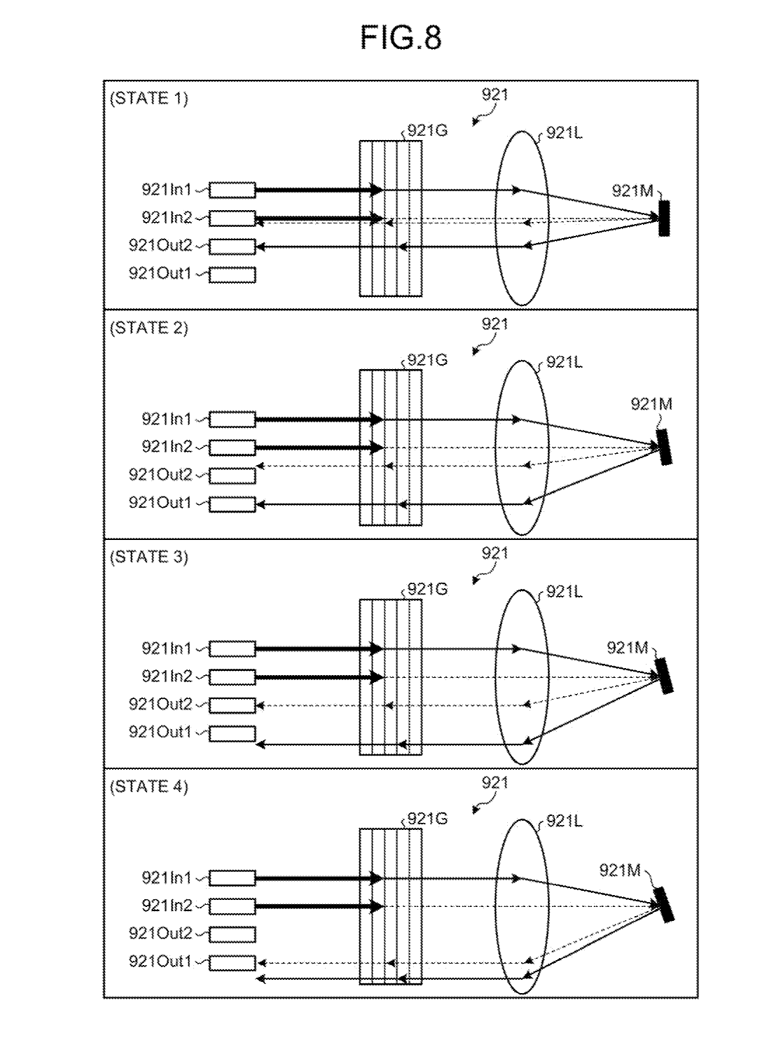

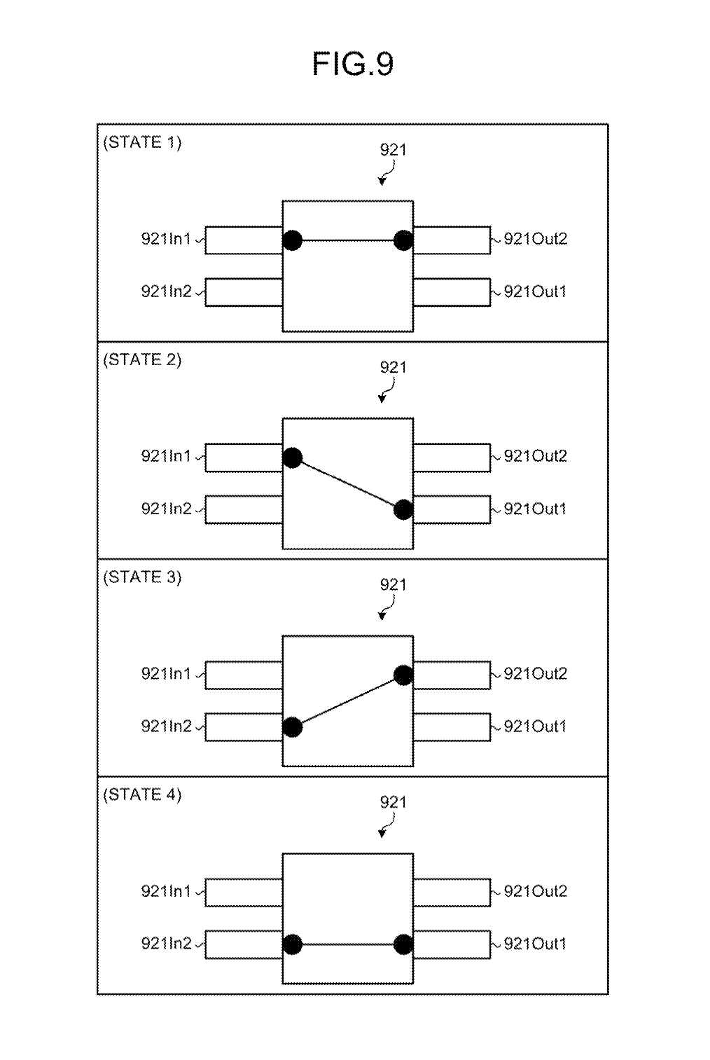

FIGS. 8 and 9 are schematic diagrams of the WSS 921 in which one port is added to the WSS illustrated in FIG. 5. As illustrated in FIG. 8, the WSS 921 includes input ports 921In1 and 921In2, output ports 921Out1 and 921Out2, a diffraction grating 921G, a lens 921L, and a mirror 921M. The WSS 921 illustrated in FIG. 8 is a WSS in which one output port 921Out1 is added to a WSS including two input ports 921In1 and 921In2 and one output port 921Out2.

First, in an example illustrated in FIG. 8 (state 1), the mirror 921M is disposed so that a signal light input into the input port 921In1 is reflected to the output port 921Out2. In this case, as illustrated in FIG. 9 (state 1), a signal light is transmitted and received between the input port 921In1 and the output port 921Out2. However, as illustrated in FIG. 8 (state 1) and FIG. 9 (state 1), a signal light input into the input port 921In2 is not reflected to the output port 921Out1. Therefore, in the example illustrated in FIG. 8 (state 1), the switching operation described in the above (1) cannot be performed.

In an example illustrated in FIG. 8 (state 2), the mirror 921M is disposed so that a signal light input into the input port 921In1 is reflected to the output port 921Out1. In this case, as illustrated in FIG. 9 (state 2), a signal light is transmitted and received between the input port 921In1 and the output port 921Out1. However, as illustrated in FIG. 8 (state 2) and FIG. 9 (state 2), a signal light input into the input port 921In2 is not reflected to the output port 921Out2. Therefore, in the example illustrated in FIG. 8 (state 2), the switching operation described in the above (1) cannot be performed.

In an example illustrated in FIG. 8 (state 3), the mirror 921M is disposed so that a signal light input into the input port 921In2 is reflected to the output port 921Out2. In this case, as illustrated in FIG. 9 (state 3), a signal light is transmitted and received between the input port 921In2 and the output port 921Out2. However, as illustrated in FIG. 8 (state 3) and FIG. 9 (state 3), a signal light input into the input port 921In1 is not reflected to the output port 921Out1. Therefore, in the example illustrated in FIG. 8 (state 3), the switching operation described in the above (1) cannot be performed.

In an example illustrated in FIG. 8 (state 4), the mirror 921M is disposed so that a signal light input into the input port 921In2 is reflected to the output port 921Out1. In this case, as illustrated in FIG. 9 (state 4), a signal light is transmitted and received between the input port 921In2 and the output port 921Out1. However, as illustrated in FIG. 8 (state 4) and FIG. 9 (state 4), a signal light input into the input port 921In1 is not reflected to the output port 921Out2. Therefore, in the example illustrated in FIG. 8 (state 4), the switching operation described in the above (1) cannot be performed.

As described above, even when one output port is added to a WSS which includes two input ports and one output port, a WSS that can perform the switching operations described in the above (1) and (2) cannot be realized.

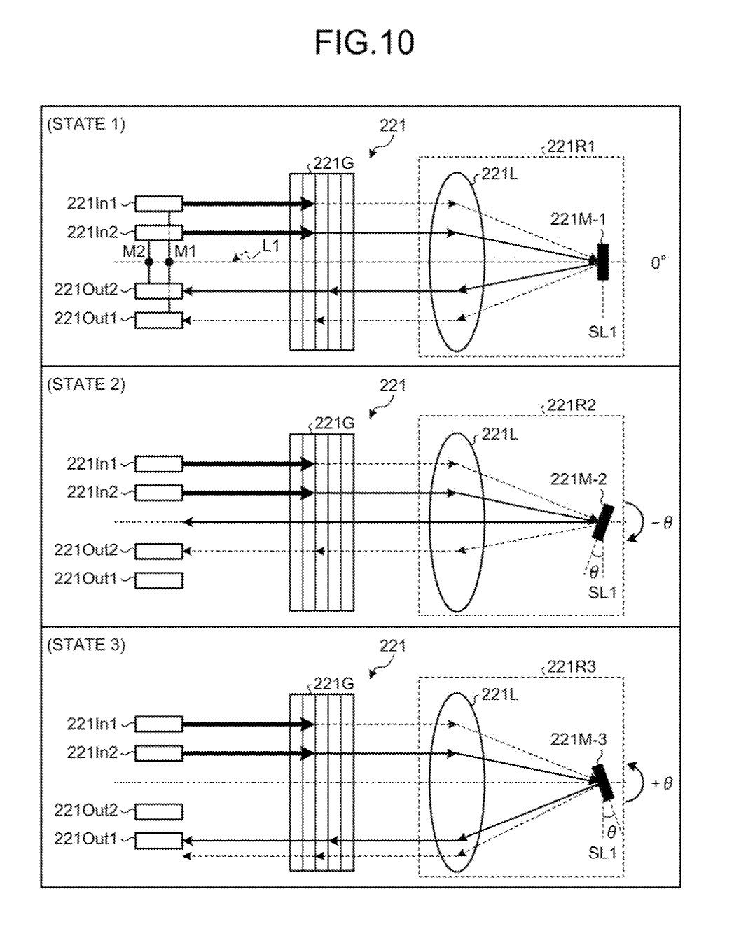

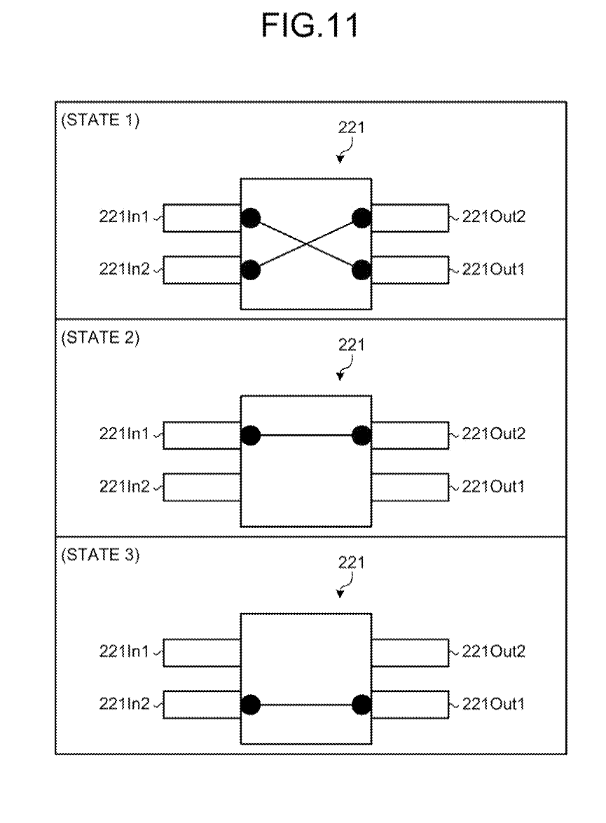

Next, the configuration of the WSS 221 illustrated in FIG. 7 will be described with reference to FIGS. 10 and 11. FIGS. 10 and 11 are schematic diagrams of the WSS 221 illustrated in FIG. 7. In (state 1) to (state 3) in FIGS. 10 and 11, examples are illustrated in which reflection angles of mirrors (mirrors 221M-1 to 221M-3 described below) included in the WSS 221 are different from each other.

As illustrated in FIG. 10 (state 1), the WSS 221 includes the first input port 221In1, the second input port 221In2, the first output port 221Out1, and the second output port 221Out2. A signal light is input into the first input port 221In1 and the second input port 221In2. The first output port 221Out1 and the second output port 221Out2 output a signal light having at least a part of wavelengths included in the signal light input into the first input port 221In1 or the second input port 221In2.

As illustrated in FIG. 10 (state 1), the WSS 221 includes a diffraction grating 221G and a first reflection unit 221R1. The diffraction grating 221G is a divider/combiner which divides a signal light input into the first input port 221In1 or the second input port 221In2 into signal lights of each wavelength and combines a plurality of signal lights.

The first reflection unit 221R1 reflects a signal light having a first wavelength which is divided from the signal light input into the first input port 221In1 by the diffraction grating 221G to the first output port 221Out1. Further, the first reflection unit 221R1 reflects a signal light having the first wavelength which is divided from the signal light input into the second input port 221In2 by the diffraction grating 221G to the second output port 221Out2.

Specifically, the first reflection unit 221R1 includes a lens 221L and the first mirror 221M-1. The lens 221L is the same as the lens 121L illustrated in FIG. 5. The first mirror 221M-1 is disposed on a straight line L1 connecting the center M1 of a line segment whose ends are the first input port 221In1 and the first output port 221Out1 and the center M2 of a line segment whose ends are the second input port 221In2 and the second output port 221Out2.

Here, as illustrated in FIG. 10 (state 1), the first mirror 221M-1 is disposed at an angle which reflects a signal light incoming from the first input port 221In1 to the first output port 221Out1. In an example illustrated in FIG. 10 (state 1), the first mirror 221M-1 is disposed so that an angle between the first mirror 221M-1 and the predetermined reference line SL1 is “0°”. In this case, the first mirror 221M-1 can reflect a signal light incoming from the second input port 221In2 to the second output port 221Out2. This is because the first mirror 221M-1 is disposed on the straight line L1 connecting the center M1 and the center M2.

In this way, the WSS 221 can perform the switching operation described in the above (1) in the manner of the example illustrated in FIG. 10 (state 1). Specifically, in FIG. 10 (state 1), as illustrated in FIG. (state 1), a signal light is transmitted and received between the first input port 221In1 and the first output port 221Out1, and a signal light is transmitted and received between the second input port 221In2 and the second output port 221Out2.

In an example illustrated in FIG. 10 (state 2), the WSS 221 includes a second reflection unit 221R2. The second reflection unit 221R2 reflects a signal light having a second wavelength which is divided from the signal light input into the first input port 221In1 by the diffraction grating 221G to the second output port 221Out2.

Specifically, the second reflection unit 221R2 includes the second mirror 221M-2 which reflects a signal light incoming from the first input port 221In1 to the second output port 221Out2. In the example illustrated in FIG. 10 (state 2), the second mirror 221M-2 is disposed so that an angle between the second mirror 221M-2 and the reference line SL1 is “−θ”.

In this way, the WSS 221 can perform the switching operation described in the above (2) in the manner of the example illustrated in FIG. 10 (state 2). Specifically, in the example illustrated in FIG. 10 (state 2), as illustrated in FIG. 11 (state 2), a signal light is transmitted and received between the first input port 221In1 and the second output port 221Out2.

In an example illustrated in FIG. 10 (state 3), the WSS 221 includes a third reflection unit 221R3. The third reflection unit 221R3 includes the third mirror 221M-3 which reflects a signal light incoming from the second input port 221In2 to the first output port 221Out1. In the example illustrated in FIG. 10 (state 3), the third mirror 221M-3 is disposed so that an angle between the third mirror 221M-3 and the reference line SL1 is “+θ”. Specifically, in the example illustrated in FIG. 10 (state 3), as illustrated in FIG. 11 (state 3), a signal light is transmitted and received between the second input port 221In2 and the first output port 221Out1.

As described above, the WSS 221 according to the third embodiment includes the first mirror 221M-1 disposed on the straight line L1 connecting the center M1 and the center M2 illustrated in FIG. 10 and the second mirror 221M-2, and thereby the WSS 221 can perform the switching operations described in the above (1) and (2).

For example, a mirror which a signal light having a wavelength corresponding to the direct detection signal strikes among the mirrors included in the WSS 221 is disposed at a position and an angle illustrated in FIG. 10 (state 1). Also, for example, a mirror which a signal light having a wavelength corresponding to the digital coherent signal strikes among the mirrors included in the WSS 221 is disposed at a position and an angle illustrated in FIG. 10 (state 2). Based on this, the WSS 221 can output the direct detection signal included in the wavelength-multiplexed signal light to the light signal processing unit 130 via the first output port 221Out1. Also, the WSS 221 can combine the direct detection signal input from the light signal processing unit 130 via the second input port 221In2 and the digital coherent signal included in the wavelength-multiplexed signal light. Further, the WSS 221 can output the combined wavelength-multiplexed signal light to the OADM apparatus 140 via the second output port 221Out2.

### Effect of the Third Embodiment

As described above, by using one WSS 221, the repeater 200 according to the third embodiment divides the wavelength-multiplexed signal light into the digital coherent signal and the direct detection signal and combines the digital coherent signal and the dispersion-compensated direct detection signal. Based on this, the repeater 200 according to the third embodiment can relay the wavelength-multiplexed signal light in which the digital coherent signal and the direct detection signal are wavelength-multiplexed by a small-scale configuration. As a result, according to the third embodiment, it is possible to save the time and cost required for the design and manufacturing.

### [d] Fourth Embodiment

In the third embodiment described above, the repeater 200 including the WSS 221 illustrated in FIGS. 10 and 11 is described. However, the configuration of the WSS including two input ports and two output ports is not limited to the example illustrated in FIGS. 10 and 11. In the fourth embodiment, other configuration examples of a WSS including two input ports and two output ports will be described.

### Configuration Example of 2×2 WSS (1)

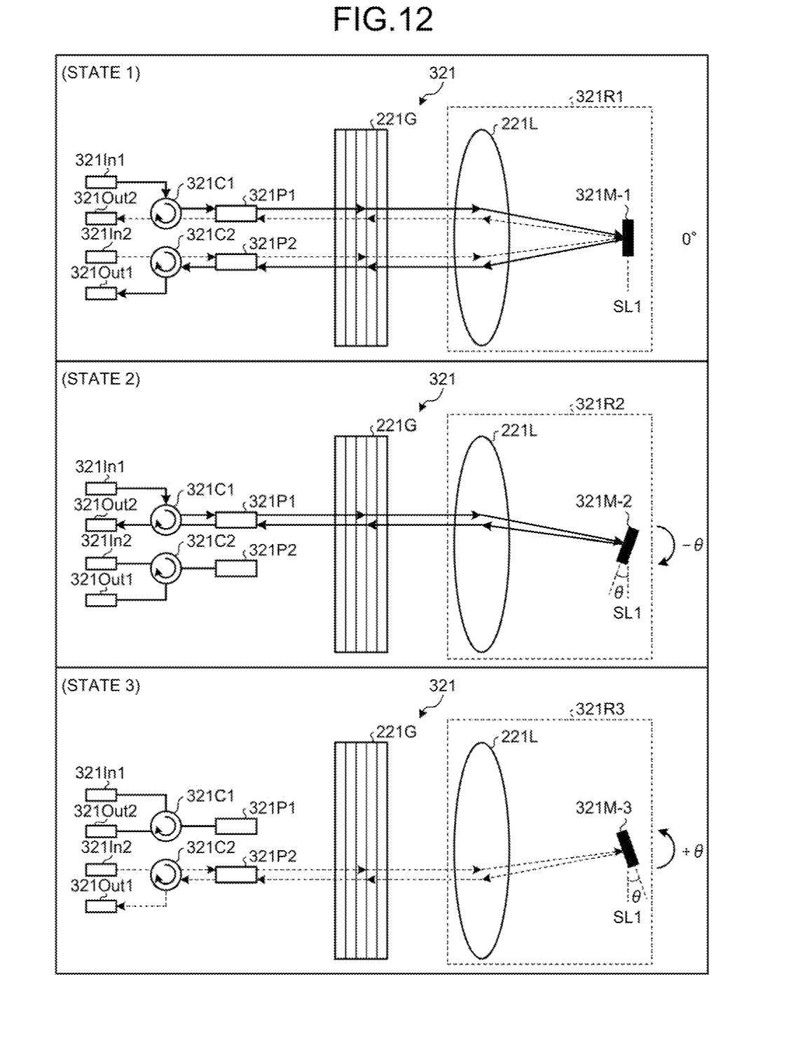

First, a configuration example of a WSS 321 including two input ports and two output ports will be described with reference to FIG. 12. FIG. 12 is a schematic diagram of the WSS 321 according to the fourth embodiment. In (state 1) to (state 3) in FIG. 12, examples are illustrated in which reflection angles of mirrors (mirrors 321M-1 to 321M-3 described below) included in the WSS 321 are different from each other.

As illustrated in FIG. 12 (state 1), the WSS 321 includes a first input port 321In1, a second input port 321In2, a first output port 321Out1, and a second output port 321Out2. The first input port 321In1 and the second input port 321In2 respectively correspond to the first input port 221In1 and the second input port 221In2 illustrated in FIG. 10. The first output port 321Out1 and the second output port 321Out2 respectively correspond to the first output port 221Out1 and the second output port 221Out2 illustrated in FIG. 10.

The WSS 321 includes a first circulator 321C1 and a second circulator 321C2. The first circulator 321C1 outputs a signal light input into the first input port 321In1 in a direction of the diffraction grating 221G and outputs a signal light input from a direction of the diffraction grating 221G to the second output port 321Out2. The second circulator 321C2 outputs a signal light input into the second input port 321In2 in a direction of the diffraction grating 221G and outputs a signal light input from a direction of the diffraction grating 221G to the first output port 321Out1.

The WSS 321 includes a port 321P1 and a port 321P2. The port 321P1 is, for example, an optical fiber array, and transmits and receives a signal light to and from the first circulator 321C1. The port 321P2 is, for example, an optical fiber array, and transmits and receives a signal light to and from the second circulator 321C2.

As illustrated in FIG. 12 (state 1), the WSS 321 includes a first reflection unit 321R1. The first reflection unit 321R1 includes a first mirror 321M-1. The first mirror 321M-1 is disposed on a straight line connecting the center of a line segment whose ends are the first input port 321In1 and the first output port 321Out1 and the center of a line segment whose ends are the second input port 321In2 and the second output port 321Out2.

Here, as illustrated in FIG. 12 (state 1), the first mirror 321M-1 is disposed at an angle which reflects a signal light incoming from the first circulator 321C1 to the second circulator 321C2. In an example illustrated in FIG. 12 (state 1), the first mirror 321M-1 is disposed so that an angle between the first mirror 321M-1 and the predetermined reference line SL1 is “0°”. In this case, the first mirror 321M-1 can reflect a signal light incoming from the second circulator 321C2 to the first circulator 321C1.

Therefore, in the example illustrated in FIG. 12 (state 1), a signal light input into the first input port 321In1 strikes the first mirror 321M-1 through the first circulator 321C1 and the diffraction grating 221G. The first mirror 321M-1 reflects the incoming signal light to the second circulator 321C2. The signal light entering the second circulator 321C2 is output from the first output port 321Out1.

Also, in the example illustrated in FIG. 12 (state 1), a signal light input into the second input port 321In2 strikes the first mirror 321M-1 through the second circulator 321C2 and the diffraction grating 221G. The first mirror 321M-1 reflects the incoming signal light to the first circulator 321C1. The signal light entering the first circulator 321C1 is output from the second output port 321Out2.

In this way, the WSS 321 can perform the switching operation described in the above (1) in the manner of the example illustrated in FIG. 12 (state 1). Specifically, in the example illustrated in FIG. 12 (state 1), a signal light is transmitted and received between the first input port 321In1 and the first output port 321Out1, and a signal light is transmitted and received between the second input port 321In2 and the second output port 321Out2.

In an example illustrated in FIG. 12 (state 2), the WSS 321 includes a second reflection unit 321R2. The second reflection unit 321R2 includes the second mirror 321M-2 disposed at an angle which reflects a signal light incoming from the first circulator 321C1 to the first circulator 321C1.

In the example illustrated in FIG. 12 (state 2), a signal light input into the first input port 321In1 strikes the second mirror 321M-2 through the first circulator 321C1 and the diffraction grating 221G. The signal light is reflected by the second mirror 321M-2 to the first circulator 321C1. The signal light entering the first circulator 321C1 is output from the second output port 321Out2.

In this way, the WSS 321 can perform the switching operation described in the above (2) in the manner of the example illustrated in FIG. 12 (state 2). Specifically, in the example illustrated in FIG. 12 (state 2), a signal light is transmitted and received between the first input port 321In1 and the second output port 321Out2.

In an example illustrated in FIG. 12 (state 3), the WSS 321 includes a third reflection unit 321R3. The third reflection unit 321R3 includes the third mirror 321M-3 disposed at an angle which reflects a signal light incoming from the second circulator 321C2 to the second circulator 321C2.

In the example illustrated in FIG. 12 (state 3), a signal light input into the second input port 321In2 strikes the third mirror 321M-3 through the second circulator 321C2 and the diffraction grating 221G. The signal light is reflected by the third mirror 321M-3 to the second circulator 321C2. The signal light entering the second circulator 321C2 is output from the first output port 321Out1. As a result, in the example illustrated in FIG. 12 (state 3), a signal light is transmitted and received between the second input port 321In2 and the first output port 321Out1.

In this way, the WSS 321 illustrated in FIG. 12 can perform the switching operations described in the above (1) and (2). Therefore, the repeater 200 described in the third embodiment may use the WSS 321 illustrated in FIG. 12 instead of the WSS 221.

### Configuration Example of 2×2 WSS (2)

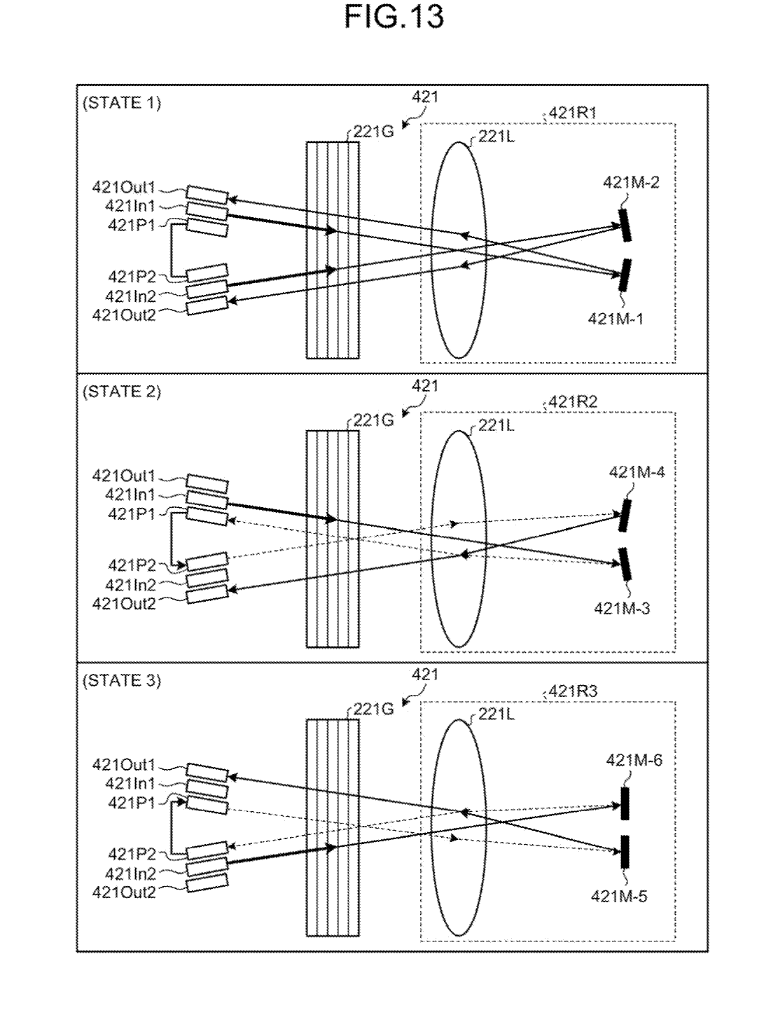

Next, a configuration example of a WSS 421 including two input ports and two output ports will be described with reference to FIG. 13. FIG. 13 is a schematic diagram of the WSS 421 according to the fourth embodiment. In (state 1) to (state 3) in FIG. 13, examples are illustrated in which reflection angles of mirrors (mirrors 421M-1 to 421M-6 described below) included in the WSS 421 are different from each other.

As illustrated in FIG. 13 (state 1), the WSS 421 includes a first input port 421In1, a second input port 421In2, a first output port 421Out1, and a second output port 421Out2. The first input port 421In1 and the second input port 421In2 respectively correspond to the first input port 221In1 and the second input port 221In2 illustrated in FIG. 10. The first output port 421Out1 and the second output port 421Out2 respectively correspond to the first output port 221Out1 and the second output port 221Out2 illustrated in FIG. 10.

The WSS 421 includes a first relay port 421P1 and a second relay port 421P2. The first relay port 421P1 and the second relay port 421P2 are, for example, optical fiber arrays, and connected to each other. For example, a signal light input into the first relay port 421P1 is output from the second relay port 421P2. Also, for example, a signal light input into the second relay port 421P2 is output from the first relay port 421P1.

As illustrated in FIG. 13 (state 1), the WSS 421 includes a first reflection unit 421R1. The first reflection unit 421R1 includes the first mirror 421M-1 and the second mirror 421M-2. As illustrated in FIG. 13 (state 1), the first mirror 421M-1 is disposed at an angle which reflects a signal light incoming from the first input port 421In1 to the first output port 421Out1. As illustrated in FIG. 13 (state 1), the second mirror 421M-2 is disposed at an angle which reflects a signal light incoming from the second input port 421In2 to the second output port 421Out2.

In this way, the WSS 421 can perform the switching operation described in the above (1) in the manner of an example illustrated in FIG. 13 (state 1). Specifically, in the example illustrated in FIG. 13 (state 1), a signal light is transmitted and received between the first input port 421In1 and the first output port 421Out1, and a signal light is transmitted and received between the second input port 421In2 and the second output port 421Out2.

In an example illustrated in FIG. 13 (state 2), the WSS 421 includes a second reflection unit 421R2. The second reflection unit 421R2 includes the third mirror 421M-3 and the fourth mirror 421M-4. As illustrated in FIG. 13 (state 2), the third mirror 421M-3 is disposed at an angle which reflects a signal light incoming from the first input port 421In1 to the first relay port 421P1. The fourth mirror 421M-4 is disposed at an angle which reflects a signal light output from the second relay port 421P2 to the second output port 421Out2. As a result, the fourth mirror 421M-4 reflects the signal light reflected to the first relay port 421P1 by the third mirror 421M-3 to the second output port 421Out2.

In this way, the WSS 421 can perform the switching operation described in the above (2) in the manner of the example illustrated in FIG. 13 (state 2). Specifically, in the example illustrated in FIG. 13 (state 2), a signal light is transmitted and received between the first input port 421In1 and the second output port 421Out2.

In an example illustrated in FIG. 13 (state 3), the WSS 421 includes a third reflection unit 421R3. The third reflection unit 421R3 includes the fifth mirror 421M-5 and the sixth mirror 421M-6. As illustrated in FIG. 13 (state 3), the sixth mirror 421M-6 is disposed at an angle which reflects a signal light incoming from the second input port 421In2 to the second relay port 421P2. The fifth mirror 421M-5 is disposed at an angle which reflects a signal light output from the first relay port 421P1 to the first output port 421Out1. As a result, the fifth mirror 421M-5 reflects the signal light reflected to the second relay port 421P2 by the sixth mirror 421M-6 to the first output port 421Out1.

In this way, the WSS 421 illustrated in FIG. 13 can perform the switching operations described in the above (1) and (2). Therefore, the repeater 200 described in the third embodiment may use the WSS 421 illustrated in FIG. 13 instead of the WSS 221.

### Configuration Example of 2×2 WSS (3)

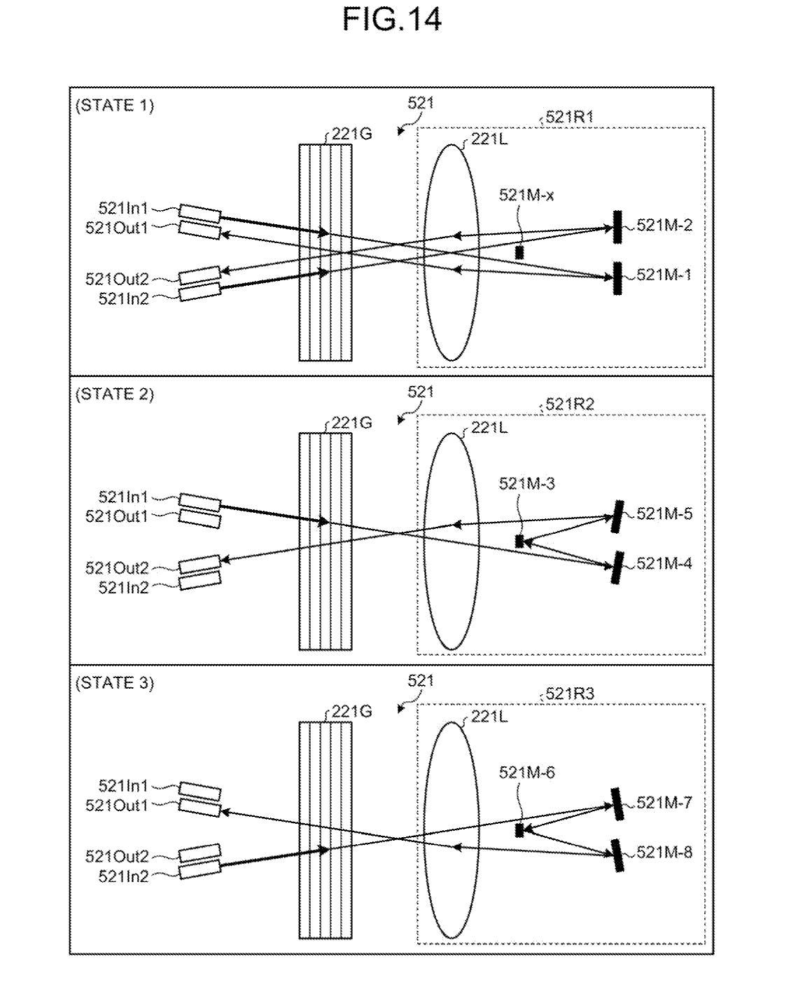

Next, a configuration example of a WSS 521 including two input ports and two output ports will be described with reference to FIG. 14. FIG. 14 is a schematic diagram of the WSS 521 according to the fourth embodiment. In (state 1) to (state 3) in FIG. 14, examples are illustrated in which reflection angles of mirrors (mirrors 521M-1 to 521M-8 described below) included in the WSS 521 are different from each other.

As illustrated in FIG. 14 (state 1), the WSS 521 includes a first input port 521In1, a second input port 521In2, a first output port 521Out1, and a second output port 521Out2. The first input port 521In1 and the second input port 521In2 respectively correspond to the first input port 221In1 and the second input port 221In2 illustrated in FIG. 10. The first output port 521Out1 and the second output port 521Out2 respectively correspond to the first output port 221Out1 and the second output port 221Out2 illustrated in FIG. 10.

As illustrated in FIG. 14 (state 1), the WSS 521 includes a first reflection unit 521R1. The first reflection unit 521R1 includes the first mirror 521M-1, the second mirror 521M-2, and a mirror 521M-x.

As illustrated in FIG. 14 (state 1), the first mirror 521M-1 is disposed at an angle which reflects a signal light incoming from the first input port 521In1 to the first output port 521Out1. As illustrated in FIG. 14 (state 1), the second mirror 521M-2 is disposed at an angle which reflects a signal light incoming from the second input port 521In2 to the second output port 521Out2. In an example illustrated in FIG. 14 (state 1), the mirror 521M-x is not used.

In this way, the WSS 521 can perform the switching operation described in the above (1) in the manner of the example illustrated in FIG. 14 (state 1). Specifically, in the example illustrated in FIG. 14 (state 1), a signal light is transmitted and received between the first input port 521In1 and the first output port 521Out1, and a signal light is transmitted and received between the second input port 521In2 and the second output port 521Out2.

In an example illustrated in FIG. 14 (state 2), the WSS 521 includes a second reflection unit 521R2. The second reflection unit 521R2 includes the third mirror 521M-3, the fourth mirror 521M-4, and the fifth mirror 521M-5.

As illustrated in FIG. 14 (state 2), the fourth mirror 521M-4 is disposed at an angle which reflects a signal light incoming from the first input port 521In1 to the third mirror 521M-3. The fifth mirror 521M-5 is disposed at an angle which reflects the signal light, which is reflected to the third mirror 521M-3 by the fourth mirror 521M-4 and reflected from the third mirror 521M-3 to the fifth mirror 521M-5, to the second output port 521Out2.

In this way, the WSS 521 can perform the switching operation described in the above (2) in the manner of the example illustrated in FIG. 14 (state 2). Specifically, in the example illustrated in FIG. 14 (state 2), a signal light is transmitted and received between the first input port 521In1 and the second output port 521Out2.

In an example illustrated in FIG. 14 (state 3), the WSS 521 includes a third reflection unit 521R3. The third reflection unit 521R3 includes the sixth mirror 521M-6, the seventh mirror 521M-7, and the eighth mirror 521M-8.

As illustrated in FIG. 14 (state 3), the seventh mirror 521M-7 is disposed at an angle which reflects a signal light incoming from the second input port 521In2 to the sixth mirror 521M-6. The eighth mirror 521M-8 is disposed at an angle which reflects the signal light, which is reflected to the sixth mirror 521M-6 by the seventh mirror 521M-7 and reflected from the sixth mirror 521M-6 to the eighth mirror 521M-8, to the first output port 521Out1.

In this way, the WSS 521 illustrated in FIG. 14 can perform the switching operations described in the above (1) and (2). Therefore, the repeater 200 described in the third embodiment may use the WSS 521 illustrated in FIG. 14 instead of the WSS 221.

### Effect of the Fourth Embodiment

As described above, the WSSs 321, 421, and 521 according to the fourth embodiment can perform the switching operations described in the above (1) and (2). Therefore, by using the WSS 321, 421, or 521, the repeater 200 according to the third embodiment can divide the wavelength-multiplexed signal light into the digital coherent signal and the direct detection signal, and combine the digital coherent signal and the dispersion-compensated direct detection signal.

### [e] Fifth Embodiment

In the above-described second embodiment, an example is described in which the OADM apparatus 140 includes the branch unit 141 and the combining unit 142. However, the OADM apparatus may include a WSS which includes two input ports and two output ports, such as the WSS 221 described in the third embodiment and the WSSs 321, 421, and 521 described in the fourth embodiment. In a fifth embodiment, an example in which the OADM apparatus includes the WSS described in the third embodiment will be described.

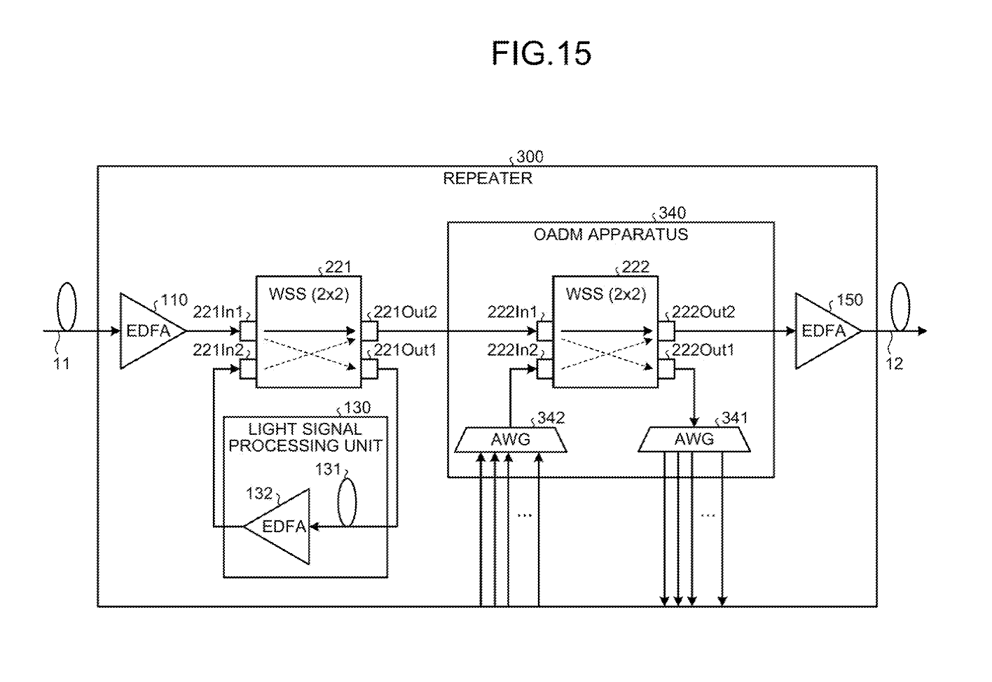

FIG. 15 is a block diagram illustrating a configuration example of a repeater according to the fifth embodiment. As illustrated in FIG. 15, a repeater 300 according to the fifth embodiment includes an OADM apparatus 340 instead of the OADM apparatus 140 which is included in the repeater 200 illustrated in FIG. 3.

As illustrated in FIG. 15, the OADM apparatus 340 includes a WSS 222, an AWG 341, and an AWG 342. A configuration of the WSS 222 is the same as the configuration of the WSS 221 described in the third embodiment. The configuration of the WSS 222 may be the same as the configuration of the WSS 321, 421, or 521 described in the fourth embodiment.

The WSS 222 includes a first input port 222In1, a second input port 222In2, a first output port 222Out1, and a second output port 222Out2. In an example illustrated in FIG. 15, the first input port 222In1 is connected to the WSS 221, and the second input port 222In2 is connected to the AWG 342. The first output port 222Out1 is connected to the AWG 341, and the second output port 222Out2 is connected to the EDFA 150.

In such a configuration, the WSS 222 divides a wavelength-multiplexed signal light input from the WSS 221 via the first input port 222In1. Then, the WSS 222 branches (drops) a signal light having a predetermined wavelength among the divided signal lights to the AWG 341 via the first output port 222Out1. The signal light branched to (dropped on) the AWG 341 is transmitted to another light receiver or the like by the AWG 341. The WSS 222 inserts (adds) a signal light having a predetermined wavelength which is input from the AWG 342 via the second input port 222In2.

For example, a wavelength-multiplexed signal light including signal lights having wavelengths λ1, λ2, λ3, and λ5 is input into the WSS 222 from the WSS 221. It is determined that the OADM apparatus 340 branches (drops) a signal light having the wavelength λ2 to the AWG 341. Also, it is determined that the OADM apparatus 340 inserts (adds) a signal light having the wavelength λ4 among signal lights input from the AWG 342.

In such a case, the WSS 222 divides the wavelength-multiplexed signal light input through the first input port 222In1 into the signal light of wavelength λ1, the signal light of wavelength λ2, the signal light of wavelength λ3, and the signal light of wavelength λ5. Then, the WSS 222 branches (drops) the divided signal light of wavelength λ2 to the AWG 341 via the first output port 222Out1.

The WSS 222 divides a signal light input from the AWG 342 via the second input port 222In2, and combines a divided signal light having a wavelength λ4 and the signal lights having the wavelengths λ1, λ3, and λ5 which are divided from the wavelength-multiplexed signal light described above. Then, the WSS 222 outputs the combined wavelength-multiplexed signal light to the EDFA 150 via the second output port 222Out2.

In an example described above, a mirror which signal lights of wavelengths λ2 and λ4 strike among the mirrors included in the WSS 222 is disposed at a position and an angle illustrated in FIG. 10 (state 1). Also, for example, a mirror which signal lights of wavelengths λ1, λ3, and λ5 strike among the mirrors included in the WSS 222 is disposed at a position and an angle illustrated in FIG. 10 (state 2). Based on this, the WSS 222 can drop a signal light of wavelength λ2 and add a signal light of wavelength λ4.

### Effect of the Fifth Embodiment

As described above, the repeater 300 according to the fifth embodiment includes the OADM apparatus 340 realized by one WSS 222. Based on this, the repeater 300 according to the fifth embodiment can realize an OADM apparatus by a small-scale configuration. Such a repeater 300 can be applied to a 3R (Reshaping Retiming Regeneration) repeater.

### [f] Sixth Embodiment

The WSS 221 described in the third embodiment and the WSSs 321, 421, and 521 described in the fourth embodiment can be allied to a repeater used in a WDM transmission path which implements a cross connection. In a sixth embodiment, an example in which the WSS described in the third embodiment is applied to a repeater implementing a cross connection will be described.

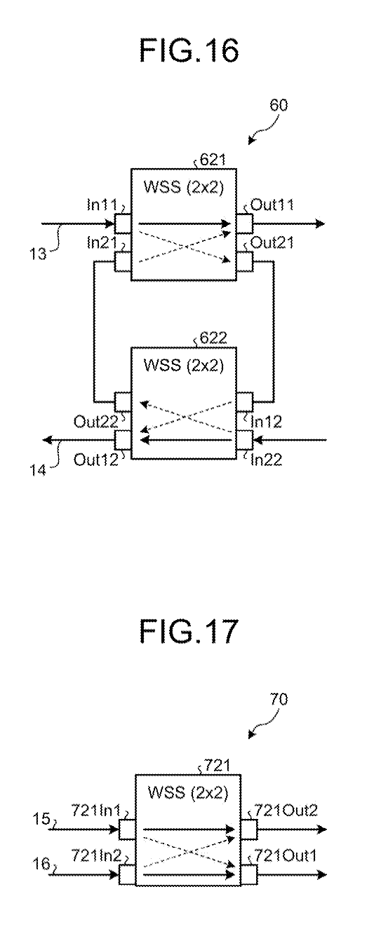

FIG. 16 is a diagram illustrating a configuration example of a WDM system according to the sixth embodiment. As illustrated in FIG. 16, in a WDM system 60 according to the sixth embodiment, a cross connection is implemented by a WSS 621 and a WSS 622. Configurations of the WSS 621 and the WSS 622 are the same as the configuration of the WSS 221 described in the third embodiment. The configurations of the WSS 621 and the WSS 622 may be the same as the configuration of the WSS 321, 421, or 521 described in the fourth embodiment.

The WSS 621 is disposed in a transmission path 13, and includes input ports In11 and In21 and output ports Out11 and Out21. The WSS 622 is disposed in a transmission path 14, and includes input ports In12 and In22 and output ports Out12 and Out22.

For example, in the transmission path 13, a wavelength-multiplexed signal light including signal lights having wavelengths λ1, λ2, λ3, and λ5 is transmitted. The WSS 621 relays a signal light having a wavelength of λ2 to the transmission path 14. In the transmission path 14, a wavelength-multiplexed signal light including signal lights having wavelengths λ1, λ3, λ4, and λ5 is transmitted. The WSS 622 relays a signal light having a wavelength of λ4 to the transmission path 13.

In such a case, the WSS 621 divides the wavelength-multiplexed signal light input from the transmission path 13 via the input port In11 into the signal light of wavelength λ1, the signal light of wavelength λ2, the signal light of wavelength λ3, and the signal light of wavelength λ5. Then, the WSS 621 outputs the divided signal light of wavelength λ2 from the output port Out21. The signal light of wavelength λ2 output from the output port Out21 is input into the WSS 622 via the input port In12.

The WSS 622 divides the wavelength-multiplexed signal light input from the transmission path 14 via the input port In22 into the signal light of wavelength λ1, the signal light of wavelength λ3, the signal light of wavelength λ4, and the signal light of wavelength λ5. Then, the WSS 622 outputs the divided signal light of wavelength λ4 from the output port Out22. The signal light of wavelength λ4 output from the output port Out22 is input into the WSS 621 via the input port In21.

The WSS 621 combines the signal light of wavelength λ4 input from the input port In21 and the signal lights of wavelengths λ1, λ3, and λ5 included in the wavelength-multiplexed signal light input from the input port In11. Then, the WSS 621 outputs the combined wavelength-multiplexed signal light to the transmission path 13 via the output port Out11.

Also, the WSS 622 combines the signal light of wavelength λ2 input from the input port In12 and the signal lights of wavelengths λ1, λ3, and λ5 included in the wavelength-multiplexed signal light input from the input port In22. Then, the WSS 622 outputs the combined wavelength-multiplexed signal light to the transmission path 14 via the output port Out12.

### Effect of the Sixth Embodiment

As described above, the WDM system 60 according to the sixth embodiment can implement a cross connection by using the WSS 221 described in the third embodiment or the WSSs 321, 421, and 521 described in the fourth embodiment.

### [g] Seventh Embodiment

In the above-described sixth embodiment, an example in which a cross connection is implemented by using two WSSs is described. However, it is possible to implement a cross connection by using one WSS. In a seventh embodiment, an example of a WDM system in which a cross connection is implemented by using one WSS will be described.

FIG. 17 is a diagram illustrating a configuration example of a WDM system 70 according to the seventh embodiment. As illustrated in FIG. 17, in the WDM system 70 according to the seventh embodiment, a cross connection is implemented by a WSS 721. Specifically, the WSS 721 includes a first input port 721In1, a second input port 721In2, a first output port 721Out1, and a second output port 721Out2.

The WSS 721 divides a wavelength-multiplexed signal light transmitted in a transmission path 15 into signal lights of each wavelength, and outputs the divided signal lights from the first output port 721Out1 or the second output port 721Out2. Also, the WSS 721 divides a wavelength-multiplexed signal light transmitted in a transmission path 16 into signal lights of each wavelength, and outputs the divided signal lights from the first output port 721Out1 or the second output port 721Out2.

For example, in the transmission path 15, a wavelength-multiplexed signal light including signal lights having wavelengths λ1, λ2, λ3, and λ5 is transmitted. The WSS 721 relays a signal light having a wavelength of λ2 included in the wavelength-multiplexed signal light transmitted in the transmission path 15 to the transmission path 16. In the transmission path 16, a wavelength-multiplexed signal light including signal lights having wavelengths λ1, λ3, λ4, and λ5 is transmitted. The WSS 721 relays a signal light having a wavelength of λ4 included in the wavelength-multiplexed signal light transmitted in the transmission path 16 to the transmission path 15.

In such a case, the WSS 721 divides the wavelength-multiplexed signal light input from the transmission path 15 via the first input port 721In1 into the signal light of wavelength λ1, the signal light of wavelength λ2, the signal light of wavelength λ3, and the signal light of wavelength λ5. Then, the WSS 721 outputs the divided signal light of wavelength λ2 from the first output port 721Out1.

Also, the WSS 721 divides the wavelength-multiplexed signal light input from the transmission path 16 via the second input port 721In2 into the signal light of wavelength λ1, the signal light of wavelength λ3, the signal light of wavelength λ4, and the signal light of wavelength λ5. Then, the WSS 721 outputs the divided signal light of wavelength λ4 from the second output port 721Out2.

At this time, the WSS 721 combines the signal lights of wavelengths λ1, λ3, and λ5 included in the wavelength-multiplexed signal light input from the transmission path 15 and the signal light of wavelength λ4 included in the wavelength-multiplexed signal light input from the transmission path 16. Then, the WSS 721 outputs the combined wavelength-multiplexed signal light to the transmission path 15 via the second output port 721Out2.

Also, the WSS 721 combines the signal lights of wavelengths λ1, λ3, and λ5 included in the wavelength-multiplexed signal light input from the transmission path 16 and the signal light of wavelength λ2 included in the wavelength-multiplexed signal light input from the transmission path 15. Then, the WSS 721 outputs the combined wavelength-multiplexed signal light to the transmission path 16 via the first output port 721Out1.

### Configuration of the WSS in the Seventh Embodiment

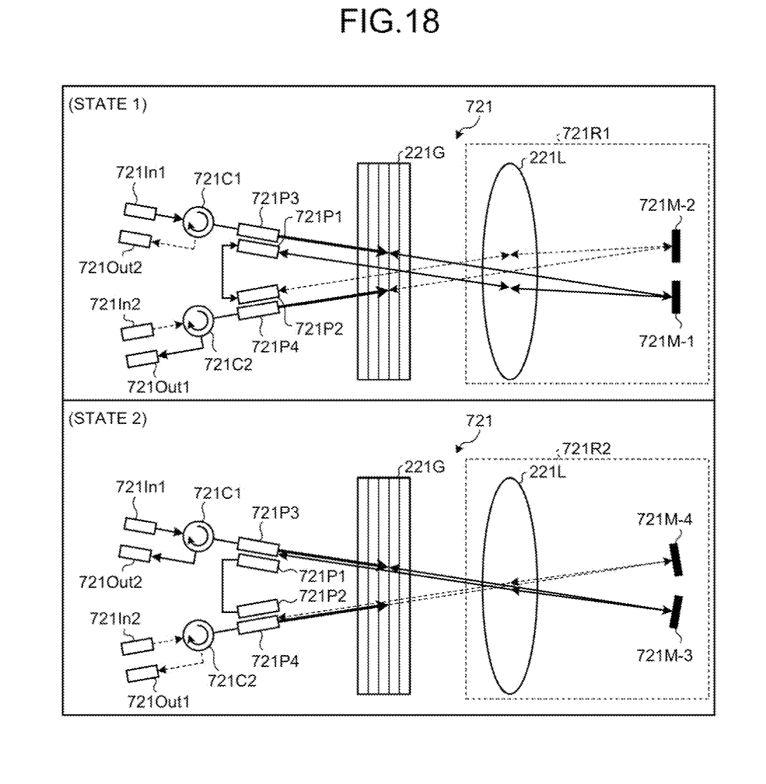

Next, a configuration of the WSS 721 illustrated in FIG. 17 will be described with reference to FIG. 18. FIG. 18 is a schematic diagram of the WSS 721 illustrated in FIG. 17. In (state 1) and (state 2) in FIG. 18, examples are illustrated in which reflection angles of mirrors (mirrors 721M-1 to 721M-4 described below) included in the WSS 721 are different from each other.

As illustrated in FIG. 18 (state 1), the WSS 721 includes a first input port 721In1, a second input port 721In2, a first output port 721Out1, and a second output port 721Out2. The first input port 721In1 and the second input port 721In2 respectively correspond to the first input port 221In1 and the second input port 221In2 illustrated in FIG. 10. The first output port 721Out1 and the second output port 721Out2 respectively correspond to the first output port 221Out1 and the second output port 221Out2 illustrated in FIG. 10.

The WSS 721 includes a first circulator 721C1 and a second circulator 721C2. The first circulator 721C1 outputs a signal light input into the first input port 721In1 in a direction of the diffraction grating 221G and outputs a signal light input from a direction of the diffraction grating 221G to the second output port 721Out2. The second circulator 721C2 outputs a signal light input into the second input port 721In2 in a direction of the diffraction grating 221G and outputs a signal light input from a direction of the diffraction grating 221G to the first output port 721Out1.

The WSS 721 includes a first relay port 721P1, a second relay port 721P2, a port 721P3, and a port 721P4. The first relay port 721P1 and the second relay port 721P2 are connected to each other. For example, a signal light input into the first relay port 721P1 is output from the second relay port 721P2. Also, for example, a signal light input into the second relay port 721P2 is output from the first relay port 721P1.

As illustrated in FIG. 18 (state 1), the WSS 721 includes a first reflection unit 721R1. The first reflection unit 721R1 includes the first mirror 721M-1 and the second mirror 721M-2. As illustrated in FIG. 18 (state 1), the first mirror 721M-1 is disposed at an angle which reflects a signal light incoming from the first circulator 721C1 to the first relay port 721P1. In other words, as illustrated in FIG. 18 (state 1), the first mirror 721M-1 reflects a signal light incoming from the first relay port 721P1 to the first circulator 721C1.

As illustrated in FIG. 18 (state 1), the second mirror 721M-2 is disposed at an angle which reflects a signal light incoming from the second circulator 721C2 to the second relay port 721P2. In other words, as illustrated in FIG. 18 (state 1), the second mirror 721M-2 reflects a signal light incoming from the second relay port 721P2 to the second circulator 721C2.

In an example illustrated in FIG. 18 (state 1), a signal light input into the first input port 721In1 strikes the first mirror 721M-1 through the first circulator 721C1. The signal light is reflected by the first mirror 721M-1 to the first relay port 721P1. The signal light entering the first relay port 721P1 is output from the second relay port 721P2. The signal light output from the second relay port 721P2 is reflected by the second mirror 721M-2 to the second circulator 721C2. The signal light entering the second circulator 721C2 is output from the first output port 721Out1.

In the example illustrated in FIG. 18 (state 1), a signal light input into the second input port 721In2 strikes the second mirror 721M-2 through the second circulator 721C2. The signal light is reflected by the second mirror 721M-2 to the second relay port 721P2. The signal light entering the second relay port 721P2 is output from the first relay port 721P1. The signal light output from the first relay port 721P1 is reflected by the first mirror 721M-1 to the first circulator 721C1. The signal light entering the first circulator 721C1 is output from the second output port 721Out2.

In summary, in the example illustrated in FIG. 18 (state 1), a signal light is transmitted and received between the first input port 721In1 and the first output port 721Out1, and a signal light is transmitted and received between the second input port 721In2 and the second output port 721Out2.

In an example illustrated in FIG. 18 (state 2), the WSS 721 includes a second reflection unit 721R2. The second reflection unit 721R2 includes the third mirror 721M-3 and the fourth mirror 721M-4.

The third mirror 721M-3 is disposed at an angle which reflects a signal light incoming from the first circulator 721C1 to the first circulator 721C1. The fourth mirror 721M-4 is disposed at an angle which reflects a signal light incoming from the second circulator 721C2 to the second circulator 721C2.

In the example illustrated in FIG. 18 (state 2), a signal light input into the first input port 721In1 strikes the third mirror 721M-3 through the first circulator 721C1. The signal light is reflected by the third mirror 721M-3 to the first circulator 721C1. The signal light entering the first circulator 721C1 is output from the second output port 721Out2.

In the example illustrated in FIG. 18 (state 2), a signal light input into the second input port 721In2 strikes the fourth mirror 721M-4 through the second circulator 721C2. The signal light is reflected by the fourth mirror 721M-4 to the second circulator 721C2. The signal light entering the second circulator 721C2 is output from the first output port 721Out1.

In summary, in the example illustrated in FIG. 18 (state 2), a signal light is transmitted and received between the first input port 721In1 and the second output port 721Out2, and a signal light is transmitted and received between the second input port 721In2 and the first output port 721Out1.

### Effect of the Seventh Embodiment

As described above, the WDM system 70 according to the seventh embodiment can implement a cross connection by using one WSS 721.

Among the processes described in the above embodiments, all or part of the processes described to be automatically performed may be manually performed. Moreover, the processing procedures, control procedures, specific names, and information including various data and parameters described in the above description and the drawings may be arbitrarily changed unless otherwise stated.

The constituent elements of the apparatuses illustrated in the drawings are functionally conceptual, and need not necessarily be physically configured as illustrated. In other words, specific forms of distribution and integration of the apparatuses are not limited to those illustrated in the drawings, and all or part of the apparatuses can be functionally or physically distributed or integrated in arbitrary units according to various loads and the state of use.

According to an aspect of the signal light processing apparatus disclosed in this application, there is an effect that the time and cost required for the design and manufacturing can be saved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A signal light processing apparatus comprising:
a first wavelength selection switch that divides an input wavelength-multiplexed signal light into signal lights of each wavelength and outputs the signal lights from a first output port or a second output port in accordance with wavelengths of the divided signal lights;
a dispersion compensator that compensates dispersion compensation on the signal light output from the first output port by the first wavelength selection switch; and
a second wavelength selection switch that combines the signal light on which dispersion compensation is compensated by the dispersion compensator and the signal light output from the second output port by the first wavelength selection switch.

2. A signal light processing apparatus comprising:
a wavelength selection switch that divides an input wavelength-multiplexed signal light into a first signal light and a second signal light in accordance with a wavelength; and
a dispersion compensator that compensates dispersion compensation on the first signal light divided by the wavelength selection switch,
wherein the wavelength selection switch combines a signal light on which dispersion compensation is compensated by the dispersion compensator and the second signal light.

3. The signal light processing apparatus according to claim 2, wherein
the dispersion compensator further comprises an optical amplifier that optically amplifies a signal light on which dispersion compensation has been compensated, and
the wavelength selection switch combines a signal light which is optically amplified by the optical amplifier and the second signal light.

4. A light transmission apparatus comprising:
the signal light processing apparatus according to claim 1; and
an optical add drop multiplexing apparatus that receives a wavelength-multiplexed signal light combined by the signal light processing apparatus and transmits the received wavelength-multiplexed signal light.

5. A wavelength selection switch comprising:
a first input port and a second input port to which a signal light is input;
a first output port and a second output port that output a signal light having at least a part of wavelengths included in a signal light input into the first input port or the second input port;
a divider/combiner that divides a signal light input into the first input port or the second input port into signal lights of each wavelength and combines a plurality of incoming signal lights;
a first reflection unit that reflects a signal light having a first wavelength, which is divided by the divider/combiner, among signal lights input into the first input port to the first output port via the divider/combiner, and reflects a signal light having a first wavelength, which is divided by the divider/combiner, among signal lights input into the second input port to the second output port via the divider/combiner, and
a second reflection unit that reflects a signal light having a second wavelength, which is divided by the divider/combiner, among signal lights input into the first input port to the second output port via the divider/combiner.

6. The wavelength selection switch according to claim 5, wherein the first reflection unit comprises a reflection mirror which is disposed on a straight line connecting a center of a line segment whose ends are the first input port and the first output port and a center of a line segment whose ends are the second input port and the second output port.

7. The wavelength selection switch according to claim 5, further comprising:
a first relay port and a second relay port which transmit and receive an input signal light to and from each other, wherein
the first reflection unit includes
a first reflection mirror that reflects a signal light having a first wavelength, which is divided by the divider/combiner, among signal lights input into the first input port to the first output port, and
a second reflection mirror that reflects a signal light having a first wavelength, which is divided by the divider/combiner, among signal lights input into the second input port to the second output port, and
the second reflection unit includes
a third reflection mirror that reflects a signal light having a second wavelength, which is divided by the divider/combiner, among signal lights input into the first input port to the first relay port, and
a fourth reflection mirror that reflects a signal light which is reflected to the first relay port by the third reflection mirror and thereby output from the second relay port to the second output port.

8. The wavelength selection switch according to claim 5, further comprising:
a first relay port and a second relay port which transmit and receive an input signal light to and from each other, wherein
the first reflection unit includes
a first reflection mirror that reflects a signal light having a first wavelength, which is divided by the divider/combiner, among signal lights input into the first input port to the first output port, and
a second reflection mirror that reflects a signal light having a first wavelength, which is divided by the divider/combiner, among signal lights input into the second input port to the second output port, and
the second reflection unit includes
a fourth reflection mirror that reflects a signal light having a second wavelength, which is divided by the divider/combiner, among signal lights input into the first input port to a third reflection mirror, and
a fifth reflection mirror that reflects a signal light which is reflected to the third reflection mirror by the fourth reflection mirror and thereby incoming from the third reflection mirror to the second output port.

9. The wavelength selection switch according to claim 5, further comprising:
a first circulator that outputs a signal light input into the first input port in a direction of the divider/combiner and outputs a signal light incoming from the first reflection unit or the second reflection unit to the second output port,
a second circulator that outputs a signal light input into the second input port in a direction of the divider/combiner and outputs a signal light incoming from the first reflection unit or the second reflection unit to the first output port, and
a first relay port and a second relay port which transmit and receive an input signal light to and from each other,
wherein
the first reflection unit includes
a first reflection mirror that reflects a signal light having a first wavelength, which is divided by the divider/combiner, among signal lights input into the first input port to the first relay port and reflects a signal light output from the first relay port to the first circulator, and
a second reflection mirror that reflects a signal light having a first wavelength, which is divided by the divider/combiner, among signal lights input into the second input port to the second relay port and reflects a signal light output from the second relay port to the second circulator, and
the second reflection unit includes
a third reflection mirror that reflects a signal light having a second wavelength, which is divided by the divider/combiner, among signal lights input into the first input port to the first circulator, and
a fourth reflection mirror that reflects a signal light having a second wavelength, which is divided by the divider/combiner, among signal lights input into the second input port to the second circulator.

10. The light transmission apparatus according to claim 4, wherein
the optical add drop multiplexing apparatus includes the wavelength selection switch according to claim 5,
a wavelength-multiplexed signal light combined by the signal light processing apparatus is input into the first input port,
the first output port outputs a signal light having a first wavelength included in the wavelength-multiplexed signal light input into the first input port,
a wavelength-multiplexed signal light is input into the second input port from outside, and
the second output port outputs a wavelength-multiplexed signal light in which signal lights having wavelengths other than the first wavelength included in the wavelength-multiplexed signal light input into the first input port and a signal light having a second wavelength included in the wavelength-multiplexed signal light input into the second input port are combined.

11. A wavelength division multiplexing transmission system that comprises a first transmission path and a second transmission path, the wavelength division multiplexing transmission system comprising:
a first repeater that is the wavelength selection switch according to claim 5 and switches a path of a signal light included in a wavelength-multiplexed signal light transmitted in the first transmission path to the second transmission path, and
a second repeater that is the wavelength selection switch according to claim 5 and switches a path of a signal light included in a wavelength-multiplexed signal light transmitted in the second transmission path to the first transmission path.

12. A wavelength division multiplexing transmission system that comprises a first transmission path and a second transmission path, the wavelength division multiplexing transmission system comprising:
a repeater that is the wavelength selection switch according to claim 9, switches a path of a signal light included in a wavelength-multiplexed signal light transmitted in the first transmission path to the second transmission path, and switches a path of a signal light included in a wavelength-multiplexed signal light transmitted in the second transmission path to the first transmission path.

13. A signal light processing method comprising:
dividing an input wavelength-multiplexed signal light into signal lights of each wavelength and outputs the signal lights from a first output port or a second output port in accordance with wavelengths of the divided signal lights;
compensating dispersion compensation on the signal light output from the first output port; and
combining the signal light on which dispersion compensation is compensated and the signal light output from the second output port.

14. A signal light processing apparatus comprising:
a processor; and
a memory, wherein the processor executes:
dividing an input wavelength-multiplexed signal light into signal lights of each wavelength and outputs the signal lights from a first output port or a second output port in accordance with wavelengths of the divided signal lights;
compensating dispersion compensation on the signal light output from the first output port; and
combining the signal light on which dispersion compensation is compensated and the signal light output from the second output port.

15. A signal light processing apparatus comprising:
a processor; and
a memory, wherein the processor executes:
dividing an input wavelength-multiplexed signal light into a first signal light and a second signal light in accordance with a wavelength; and
compensating dispersion compensation on the first signal light divided,
wherein the dividing combines a signal light on which dispersion compensation is compensated and the second signal light.
